(19) United States
(12) Patent Application Publication
(10) Pub. No.: US 2015/0221039 A1
(43) Pub. Date: Aug. 6, 2015

(54) Computer-Implemented Method For Portfolio Construction And Indexation Of Securities Under A Noisy Market Hypothesis

(71) Applicant: Peter J. Johansson, Greenwich, CT (US)

(72) Inventor: Peter J. Johansson, Greenwich, CT (US)

(21) Appl. No.: 14/687,879

(22) Filed: Apr. 15, 2015

Related U.S. Application Data
(63) Continuation-in-part of application No. 11/957,703, filed on Dec. 17, 2007.
(60) Provisional application No. 60/871,676, filed on Dec. 22, 2006.

(51) Int. Cl. G06Q 40/06; G06F 17/30

(52) U.S. Cl. CPC G06Q 40/06; G06F 17/30342

(57) ABSTRACT

A system, method and computer program product creates a portfolio index based on fundamental, bond and stock market data and weights on constituent's fundamental value, fair value, relative value or synthesized value. An investment system may be based on a combination of fundamental metrics along with bond and stock market data to select and weight securities in a portfolio. Once a portfolio index is created, it may be used as a basis to purchase securities for the portfolio. Valuation indifferent indexes avoid overexposure to overvalued securities and underexposure to undervalued securities, as compared with conventional capitalization-weighted and price-weighted indexes.

### RELATED APPLICATION(S)

This application is a continuation-in-part of U.S. application Ser. No. 11/957,703, filed Dec. 17, 2007. The entire teachings of the above application(s) are incorporated herein by reference.

### FIELD OF INVENTION

The invention relates to a system and method of cross sectional analysis and more particularly, to portfolio selection and weighting disciplines of an investment portfolio.

### BACKGROUND OF THE INVENTION

Traditionally, there are two broad categories of securities investing and portfolio management. One is active management, wherein the securities are selected based on a strategy where the manager makes specific investments with the goal of outperforming an investment benchmark index. The other broad category is passive management, also called indexing, wherein (a) the securities are selected and weighted (to generally construct the portfolio) according to various methodologies, such as size or style, e.g., value and growth, and (b) once the selected securities of (a) are identified for the portfolio, the selected securities are placed in the portfolio in amounts weighted according to each securities market capitalization or in equal weight. Another relatively new category of portfolio management and indexing is called factor indexing (other names include, alternative, enhanced, advanced or smart beta indexes) in which a portfolio index is selected and weighted on other factors than size, style and/or market capitalization. These index portfolios may have a different objective than traditional passive investing. These indices differs from passive indexing and active management by introducing a rules-based and systematic approach that captures several of the positive attributes of passive investing while introduce an opportunity to outperform traditional market cap-weighted indexes on an risk adjusted basis.

Market cap-weighted indexes builds on the assumption of the efficient market hypothesis (EMH) which generally states that markets are inherently rational and that stock prices reflects company's fair values. However, stock markets are not always rational or efficient. As a result, market cap-weighted indexes that rely on stock price as the only indicator of fair value, by design can become overweighed in overvalued stocks and underweighted in undervalued stocks, exposing investors to a sub-optimal portfolio.

The present invention relates generally to the passive and enhanced indexing categories of portfolio management. A securities market index, by intent, reflects an entire market or a segment of a market. A passive portfolio based on an index may also reflect the entire market or segment or a subset of entire market or segment.

Indexes are generally all-inclusive of the securities within their defined markets or market segments. In most cases indexes may include each security in the proportion that its market capitalization bears to the total market capitalization of all of the included securities. The only common exceptions to market capitalization weighting are equal weighting of the included securities (for example the Value Line index or the Standard & Poors 500 Equal Weighted Stock Index, which includes all of the stocks in the S&P 500 on a list basis; each stock given equal weighting as of a designated day each year) and share price weighting, in which share prices are simply added together and divided by some simple divisor (for example, the Dow Jones Industrial Average). Conventionally, passive portfolios are built based on an index weighted using one of market capitalization weighting, equal weighting, and share price weighting.

Most commonly used stock market indices are constructed using a methodology that is based upon either the relative share prices of a sample of companies (such as the Dow Jones Industrial Average) or the relative market capitalization of a sample of companies (such as the S&P 500 Index or the FTSE 100 Index). The nature of the construction of both of these types of indices means that if the price or the market capitalization of one company rises relative to its peers it is accorded a larger weighting in the index.

Alternatively, a company whose share price or market capitalization declines relative to the other companies in the index is accorded a smaller index weighting. This can create a situation where the index, index funds, or investors who desire their funds to closely track an index, are compelled to have a higher weighting in companies whose share prices or market capitalizations have already risen and a lower weighting in companies that have seen a decline in their share price or market capitalization.

Advantages of passive investing include: a low trading cost of maintaining a portfolio that has turnover only when an index is reconstituted, typically once a year; a low management cost of a portfolio that requires no analysis of individual securities; and/or no chance of the portfolio suffering a loss—relative to the market or market segment the index reflects—because of misjudgments in individual securities selection.

Advantages of using market capitalization weighting as the basis for a passive portfolio include that the index (and therefore a portfolio built on it) remains continually “in balance” as market prices for the included securities change, and that the portfolio performance participates in (i.e., reflects) that of the securities market or market segment included in the index.

The disadvantages of market capitalization weighting passive indexes, which can be substantial, center on the fact that any undervalued securities are underweighted in the index and related portfolios, while any overvalued securities are overweighted. Also, the portfolio based on market capitalization weighting follows every market (or segment) bubble up and every market crash down. Finally, in general, portfolio securities selection is not based on a criteria that reflect a better opportunity for appreciation than that of the market or market segment overall.

Price or market capitalization based indices can contribute to a “herding” behavior on the behalf of investors by effectively compelling any of the funds that attempt to follow these indices to have a larger weighting in shares as their price goes up and a lower weighting in shares that have declined in price. This creates unnecessary volatility, which is not in the interests of most investors. It may also lead to investment returns that have had to absorb the phenomenon of having to repeatedly increase weightings in shares after they have risen and reduce weightings in them after they have fallen.

Capitalization-weighted indexes (“cap-weighted indexes”) dominate the investment industry today, with approximately $2 trillion currently invested. Unfortunately, cap-weighted indexes suffer from an inherent flaw as they overweight all overvalued stocks and underweight all undervalued stocks. This causes cap-weighted indexes to underperform relative to indexes that are immune to this shortcoming. In addition, cap-weighted indexes are vulnerable to speculative bubbles and emotional bear markets which may unnaturally drive up or down stock prices respectively.

Another alternative is equal-weighted indexes but they also suffers from its own shortcomings. One significant problem with equal-weighted indexes is that they come out of the same cap-weighted universes as cap-weighted indexes. For example, the S&P Equal Weighted Index simply re-weights the 500 equities that comprise the S&P 500, retaining the bias already inherent to cap-weighted indexes.

High turnover and associated high costs are additional problems of equal-weighted indexes. Equal-weighted indexes include small illiquid stocks, which are required to be held in equal proportion to the larger, more liquid stocks in the index. These small illiquid stocks must be traded as often as the larger stocks but at a higher cost because they are less liquid.

In view of these problems, academics and practitioners have started to develop a second generation of indexes that are attempting to solve the shortcomings of conventional solutions. The new generation of indexes is not based on conversional financial theories, i.e., based on the efficient markets hypotheses (EMH) and the Capital Asset Pricing Model (CAPM) framework for portfolio construction, but instead bases their solutions under an assumption of the noisy market hypothesis which contrasts the efficient-market hypothesis in that it claims that the prices of securities are not always the best estimate of the true underlying value of a company (stock). It argues that prices can be influenced by speculators and momentum traders, as well as by insiders and institutions that often buy and sell stocks for reasons unrelated to fundamental value, such as for diversification, liquidity and taxes. These temporary shocks referred to as “noise” can obscure the true value of securities and may result in mispricing of these securities for many years.

One such solution are fundamentally weighted indexes which do not weight securities by their size as measured by market capitalization, but instead rely on fundamental factors. Fundamentally-weighted indexes typically focus on the factor of size such as sales, earnings, dividends and book value to weight index components.

However, fundamentally weighted indexes also comes with shortcomings since they fails to effectively capture fundamental growth and risk factors arguably inherited in a cross section of risky assets such as stocks. Consequently, fundamentally-weighted indexes underweights growth companies and overweight companies with high intrinsic (idiosyncratic) volatility risk which provides for a sub-optimal portfolio.

What is desired is a system that solves the biases in fundamentally weighted indexes which underweight growth stocks and overweight stocks with high volatility risk and furthermore solving problems with market cap weighted indexes which overweight overvalued stocks and underweight undervalued stocks.

U.S. Patent Publication No. 2005/0187851 A1 (Sant) discloses a financial portfolio management and analysis system and method, which includes several different modules, one of which is a stock valuation module. This module receives a user specified ticker symbol for a specified stock and a beta estimation period, and reaches into a historical stock price database. After extracting returns for the index and the specified stock for the specified period, the module econometrically computes the beta of the stock. It combines the computed beta with the risk free rate (T-Notes) stored in a database and produces a discount rate for the specified stock. The module automatically fills in the most recent dividend paid by the stock, which dividend is extracted from a live stock data feed. After the user provides the growth rate(s) or dividends, the module estimates the current value of the stock. It also projects a future value for the stock at the end of the specified charting period and displays the results in a tabulated as well as graphical format. The stock value is computed based upon one of three formulas (constant growth, super growth or unequal dividends) as specified in the Sant reference at page 11, paragraphs 265 through 269.

Another example is U.S. Patent Publication No. 2006/0277132 A1 (Brooks) which discloses a system for aiding investors in analyzing the attributes of investments, such as stocks, by graphically displaying the relative positions of investments with respect to one another and with respect to selectable evaluation parameters and benchmarks for such investments. More specifically, the system defines data dimensions by which locations of investments will be analyzed and presented in graphical fashion, defines data sources from which attributes of the investments will be selected, and presents, in a graphical framework, the investments as a function of the defined dimensions according to locations defined by each investment's respective attributes. Examples of the various dimensions which may be used to provide the graphical presentation include momentums, valuations and other dimensions, examples of which are provided in the Brooks reference at page 4, paragraphs 35 and 36.

Another example is U.S. Pat. No. 8,380,604 Arnott et al. discloses a system, method and computer program product for using a non-price accounting data based index to determine financial objects to purchase or to sell. A system, method and computer program product creates an index based on accounting based data, as well as a portfolio of financial objects based on the index where the portfolio is weighted according to accounting based data. A passive investment system may be based on indices created from various metrics. The indexes may be built with metrics other than market capitalization weighting, price weighting or equal weighting. Non-financial metrics may also be used to build indexes to create passive investment systems. Additionally, a combination of financial non-market capitalization metrics may be used along with non-financial metrics to create passive investment systems. Once the index is built, it may be used as a basis to purchase securities for a portfolio. Specifically excluded are widely-used capitalization-weighted indexes and price-weighted indexes, in which the price of a security contributes in a substantial way to the calculation of the weight of that security in the index or the portfolio, and equal weighting weighted indexes. Valuation indifferent indexes avoid overexposure to overvalued securities and underexposure to undervalued securities, as compared with conventional capitalization-weighted and price-weighted.

Another example is U.S. Pat. No. 7,725,374 B2 Erlach et al. discloses a method, computer system, and computer program product for performing an asset analysis for at least one asset, using the Required Yield Method (RYM). The method provides first economic data relating to a first economy. The economic data includes a gross domestic product (GDP) per capita growth rate for the first economy. The economic data may further include an expected inflation rate for the first economy over a time interval. At least one asset characteristic (e.g., asset valuation) of each asset of the least one asset is computed. The at least one asset characteristic is a function of a portion of the economic data. The computing is in accordance with the RYM. The computed at least one asset characteristic is transferred to a tangible medium. The at least one asset may include an equity index, a bond, gold, a currency, a derivative, etc.

### SUMMARY OF THE INVENTION

In an exemplary embodiment a system, method and computer program product for cross sectional analysis, portfolio index construction and/or portfolio weighting for the purpose of investing is disclosed.

Exemplary embodiments use a system, method and computer program product in accordance with the present invention includes for a plurality of stocks in a subject investment portfolio: 1) selecting a fundamental metric or composite of fundamental metrics, 2) determine an average intrinsic growth rate of the fundamental metric, 3) determine the consistency rate of the fundamental metric 4) determining volatility adjusted fundamental metric by dividing the fundamental metric by (1+consistency rate), 5) weight each stock in the portfolio by its volatility adjusted fundamental metric.

In another exemplary embodiment a system, method and computer program product in accordance with the present invention includes for a plurality of stocks: 1) selecting a fundamental metric, 2) determining an annual intrinsic growth rate, 3) determining the consistency of intrinsic growth rate, 4) determine a risk premium that compensates for relative risk to a risk free asset, 5) determining a risk adjusted relative value to a risk free asset, 6) determining a forward looking risk adjusted relative value, 7) determine an annual expected return on investment, and 8) weight each stock in a portfolio based on a relative value weighted methodology.

Furthermore and in an exemplary embodiment a system, method and computer program product in accordance with the present invention includes for a plurality of stocks: 1) selecting a fundamental metric or composite of fundamental metrics, 2) determining an annual intrinsic growth rate, 3) determining the consistency rate of intrinsic growth rate, 4) determining risk adjusted fundamental metric by dividing the fundamental metric by (1+consistency rate), 5) determining a fair value for each company by dividing the risk adjusted fundamental metric by the risk free rate of return, 6) determining a forward looking fair value for each company, 7) determine portfolio weight for each stock in a portfolio by its fair value.

What is desired is a system for portfolio construction and indexation of securities that considers fundamental factors of size, growth, risk and market factors (such as bond and stock market factors) under a hypothesis that stock prices are noisy proxies of informationally efficient stock values can achieve this aim.

It is furthermore desired to create system that analyzes fundamental factors of size, growth (the reward factor) and volatility (the risk factor) on determining a fundamental measure for risky assets (stocks).

These and other objects are achieved by the provision of a computer system for cross sectional security analysis and portfolio construction under a noisy market hypothesis, which are described herein.

Under a noisy market hypothesis it is desirable to avoid the price factor, i.e., the market value for a company, in determining a fair value for risky assets (stocks), that is since market data may contain noise and therefore not adequately reflects the underlying values of a company.

Desirable factors to include in a fair value assessment would be the factor of size, which represents the size as measured by sales, earnings, cash flows, dividends, etc. Other factors are growth and volatility which affects a fair value assessment for individual risky assets (stocks).

The growth and volatility factors can furthermore be viewed as reward and risk factors which characteristics differs significantly across individual securities. Other factors such as interest rates also has an effect on stocks fair values since the cost of capital may have various impacts on company's earnings, cash flows etc.

In determining a fair value for risky assets it may consequently be desired to capture these factors in coherent framework for security analysis.

It is furthermore desirable to keep the size factor optional in determining a fair value for risky assets. This is because the size factor creates concentration risk in a conventional constructed equity portfolio.

Still further what is desired then is a highly accurate and predictable system and method for determining the value of stock investments.

It is further desired to provide a system and method that adjusts a fair value of stocks in a population in order to yield a current annual compounding rate of return on investment comparable to the stock in the population having the highest current annual compounding rate of return on investment.

These and other objects are achieved by the provision of a system and method for determining the profitability of stock investments, which are provided below.

A stock probability determination method in accordance with the present invention includes four major steps: 1) determining the fair value of a particular stock; 2) determining the annual compounding intrinsic return of the company; 3) determining the consistency of the intrinsic return; and 4) determining the current annual compounding rate of return on investment. While step 1 is listed separate from step 3, it is contemplated that these steps could be combined.

“Fair value” for this application is defined as the relative value to the risk free rate of, for example, a ten-year U.S. Treasury Note. For earnings, the previous year's Generally Accepted Accounting Principles (GAAP) earnings are used. Alternatively, the consensus earnings estimate for the current year may be used.

“Risk Free Rate” for this application is defined as the best competitive rate of return that does not involve taking a risk. Both the return of the original capital and the payment of interest are completely certain. In a preferred embodiment, a current ten-year U.S. Treasury note rate represents the risk free rate.

“Rolling Earnings per Share (EPS)” for this application is defined as measuring a company's EPS by using the previous two quarters and adding them to the following two quarter's estimated EPS.

Optionally, step 3 (of the stock probability determination method) could be combined with step 1. As used in this application, “risk” is defined as the consistency ratio expressed as a factor on the company's ten-year historical annual compounding earning return (intrinsic return). A consistency ratio factor of (0) indicates a 100% consistent return record. When determining the fair value, the consistency ratio multiplied with the risk free rate is the risk premium. The risk premium is added to the risk free rate to create a new discount rate as noted below.

Annual compounding earning return (intrinsic return) is defined and determined by the company's ten-year historical annual compounding rate of return or Compounding Annual Growth Rate (CAGR) on earnings. Alternatively, Return On Equity (ROE) or Return on Total Capital (ROTC) may be employed.

Consistency of intrinsic return is defined and determined by the consistency ratio of the ten-year historical annual compounding return rate in earnings. It is determined by the consistency ratio of the ten year historical annual or quarterly (year by year growth rate records) compounding intrinsic return. The consistency ratio is expressed as a factor—Relative Strength Differential is calculated to get a measure of relative risk. Higher consistency ratio translates to higher risk and vice versa. Again, this step may be combined with the step of determining a fair value for the particular stock.

Current annual compounding rate of return on investment is determined by calculating the annual compounding rate of return between current stock price and the ten-year calculated intrinsic value.

It is additionally contemplated that a method for determining fair value for a stock from a competitive perspective can be provided. This method may be used in conjunction with the method described above. For example, the method could further include determining fair value of stocks in a population (index) based on a ranking system where a computer system, at any given moment, calculates the number one ranked company based on its “Current Annual Compounding Rate of Return on Investment” according to the above-described method.

A system for portfolio construction and indexation of a plurality of stocks to a benchmark of investable bonds, comprises: a computer connected to a network, said computer receiving real time data associated with the plurality of stocks; a storage medium connected to said computer and having a program stored thereon, the program is implemented to simultaneously index (select and weight, i.e., automatically adjust) the stocks by the following method.

In one advantageous embodiment a method of portfolio construction and indexation of a plurality of stocks in a portfolio comprises: a. determining a relative value for each stock in the plurality of stocks at time (t₀) by calculating a relative value by dividing a stocks Earnings Per Share at (t₀) by a Risk Free Rate at time (t₀), where time (t₀) is the present time; b. calculating an intrinsic return rate for each stock in the plurality of stocks for a period of time (t₀-t−ₙ), by dividing the relative value of the stock at time (t₀) by the calculated relative value at time (t−ₙ), where time (t−ₙ) is a point in time in the past, such that the intrinsic return rate is calculated exclusive of a price of the stock; c. determining a consistency of intrinsic return rate for each stock in the plurality of stocks by calculating a deviation of returns for periodically determined values for the period (t₀-t−ₙ), and then dividing the deviation by the intrinsic return rate; d. calculating a discount rate at time (t₀) for each stock in the plurality of stocks by multiplying the consistency of intrinsic return rate by the Risk Free Rate at time (t₀) to generate a risk premium, and adding the risk premium to the Risk Free Rate at time (t₀); e. generating a risk adjusted relative value at time (t₀) for each stock in the plurality of stocks by dividing the earnings at (t₀) by the discount rate at (t₀); f. calculating a risk adjusted future relative value at time (tₙ) for each stock in the plurality of stocks at time (t₀) by multiplying the risk adjusted relative value at (t₀) with ((1+intrinsic return rate at t₀)̂ number of periods), where time (tₙ) is a point in time in the future; g. generating a risk adjusted rate of return on investment at time (t₀) for each stock in the plurality of stocks by dividing the risk adjusted relative future value at time (tₙ) by a market price for the stock at time (t₀); and h. generating a portfolio index of stocks at time (t₀) based on the risk adjusted expected return on investment for each stock in the plurality of stocks to the benchmark of investable bonds. In this way, the portfolio is automatically adjusted using an enhanced passive systematic management of the securities (stocks) therein.

In another advantageous embodiment a system for portfolio construction and indexation (the portfolio have a plurality of stock investments) comprises: a computer operably coupled to a network; a database operably coupled to said computer of having real time and historical information relating to a plurality of stocks and treasury bonds and accessible by said computer; said computer configured to execute software to determine a value for each of a plurality of stocks (in a subject portfolio) at time (t₀) by calculating a relative value by dividing a Earnings Per Share (EPS) by a Risk Free Rate at time (t₀), where time (t₀) is the present time, EPS includes diluted earnings per share, and Risk Free Rate includes a treasury note rate; said computer configured to execute software to calculate an intrinsic return for each of the plurality of stocks for a period of time (t₀-t−ₙ), where time (t−ₙ) is a point in time in the past, by dividing the value of the stock at time (t₀) by a calculated value at time (t−ₙ), such that the intrinsic return is calculated exclusive of a market price of the stock; said computer configured to execute software to determine a consistency of intrinsic return rate for each of the plurality of stocks by calculating a deviation of returns for periodically determined values for the period (t₀-t−ₙ), and then dividing the deviation by the intrinsic return; said computer configured to execute software to calculate a discount rate at time (t₀) for each of the plurality of stocks by multiplying the consistency of intrinsic return rate by the Risk Free Rate at time (t₀) to generate a risk premium, and adding the risk premium to the Risk Free Rate at time (t₀); said computer configured to execute software to generate a risk adjusted value at time (t₀) for each of the plurality of stocks by dividing the EPS at (t₀) by the discount rate at (t₀); said computer configured to execute software to calculate a future value at time (tₙ) for each of the plurality of stocks by extrapolating the risk adjusted value at time (t₀) with the intrinsic return, where time (tₙ) is a point in time in the future; said computer configured to execute software to generate a risk adjusted expected rate of return on investment for each of the plurality of stocks by dividing the future value at time (tₙ) by a price for the stock at time (t₀); and said computer configured to execute software to automatically adjust (or otherwise passively manage) the given portfolio by simultaneously generating an index (portfolio selection and weighting) of stocks at time (t₀) based on the risk adjusted expected rate of return for each of the plurality of stocks to the benchmark of investable treasury bonds; and a display operably coupled to said computer displaying said index of stocks.

In still another advantageous embodiment a method for determining the profitability on stock investments (for portfolio construction and indexation) is provided comprising the steps of calculating the fair value of a stock according to the following equation:

$$\frac{Rolling EPS}{Last 5 Days Average Risk Free Rate}$$

where Rolling EPS is Rolling Earnings Per Share (EPS) and is a measurement of a company's EPS by using the previous two quarters and adding them to the following two quarter's estimated EPS. The method further comprises the step of calculating the annual compounding intrinsic return according to the following equation:

$${( \frac{Future Value + Accumulated Distributions}{Present Value} )}^{( 1 / n )} - 1$$

where Future Value is a company's historical relative value to the risk free rate at the end of a ten-year period; Accumulated Distributions is the sum of dividend payments and other distributions during the ten-year period; and Present Value is a company's historical relative value to the risk free rate at the beginning of the ten-year period. The method further comprises the step of determining the consistency of intrinsic return rate according to the following equation:

$$Consistency = \frac{\begin{matrix}Standard Deviation of 10 Yr ( Year by Year Growth Records ) \\ of the Relative Value to the Risk Free Rate\end{matrix}}{10 Y r Annual Compounding Intrinsic Return}$$

and generating the current annual compounding rate of return investment according to the following equation:

$${( \frac{Future Value}{Current Price} )}^{( 1 / n )} - 1$$

where Current Price is the current stock price.

Other objects of the invention and its particular features and advantages will become more apparent from consideration of the following drawings and accompanying detailed description.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a graph illustrating intrinsic return rate, deviation and consistency rate.

FIG. 2 is a graph illustrating risk adjusted fair values for a risky asset.

FIG. 3 is a graph illustrating price, fair values and intrinsic return.

FIG. 4 is a graph illustrating risk adjusted intrinsic return rate.

FIG. 5 illustrates an exemplary alternative determination of risk premium, risk adjusted earnings and fair value.

FIG. 6 illustrates an exemplary synthesized portfolio weighting methodology (incl. size factor).

FIG. 7 illustrates an exemplary relative value weighting methodology (excl. size factor).

FIG. 8 illustrates exemplary determination of risk adjusted earnings and fair values based on individual assets risk/reward characteristics.

FIG. 9 illustrates computer system implementing an exemplary embodiment of the present invention.

FIG. 10 illustrates an exemplary process flow diagram of an index generation process in accordance with an exemplary embodiment of the present invention.

FIG. 11 illustrates Exemplary Computer System That May Be Used In Implementing An Exemplary Embodiment Of The Present Invention.

FIG. 12 illustrates A Block Diagram 400 Of An Exemplary System According To An Exemplary Embodiment.

FIG. 13 illustrates Predictability Of Investment Returns Using Relative Value Weighting Methodology.

FIG. 14 illustrates A Hypothetical Stock In Risk/Reward Equilibrium To A Risk Free Bond.

FIG. 15 illustrates an Exemplary Embodiment Of Common Constituent Weight

### DETAILED DESCRIPTION OF THE INVENTION

A description of example embodiments of the invention follows.

The teachings of all patents, published applications and references cited herein are incorporated by reference in their entirety.

A fundamental metric such as for example earnings may be defined as net earnings, earnings before interest, taxes amortization (EBITA), cash flow or any other measure of earnings. Furthermore, earnings may be defined as either earnings which represent all outstanding shares for a company or on a per share basis (EPS). Earnings may further be defined as basic earnings, adjusted and/or fully diluted earnings basis.

In this application, a fundamental metric and/or a market price may represent a total value, as a measure of firm size or alternatively as a measure where the total value is divided by shares outstanding, i.e., as a per share measure. It is contemplated that both alternatives could be used throughout this application.

A “Relative Value” is a risky assets relative value to a risk free asset. A relative value is calculated by dividing risky assets earnings with the return generated by a risk free asset. A risky asset (stock) relative value to a risk free asset (bond) can be formulized as, E_{RA}/Y_{RFA}, where E represents a companies (risky assets, RA) earnings and Y represents the yield for a risk free asset (RFA).

Risk for risky assets may be defined in terms of the variance in actual returns around the expected return. A risk premium that accounts for relative volatility risk across risky assets to the benchmark of a risk free asset may be expressed as:

$$Risk Premium = [ \frac{{σ}_{( μ ) Ra} - {σ}_{Rfr}}{{μ}_{Ra}} ] \times Rfr$$

Where, σ may be a standard or semi deviation of expected return, Ra is a risky asset, is an expected return for a risky asset, and the Rfa is a risk free assets return. Note that the equation also considers inflation indexed bonds which may have some deviation of returns, i.e., variable interest rate. Such risk premium may be added to a risk free rate to generate a discount rate. The discount rate is used to discount a fundamental metric such as for example cash flows. The risk premium compensates for relative risk across risky assets (stocks) and risk free assets (bonds) and where the risk free rate account for the time value of capital.

When a risk free asset is defined as one with no deviation of actual returns around its expected return, the risk free asset would have a risk to reward (consistency rate) factor of zero “0”, which may be expressed as:

$$Risk Free Asset = \frac{{σ}_{( μ )}}{μ} = 0$$

Where the σ is the standard deviation of actual return and μ represents the expected return.

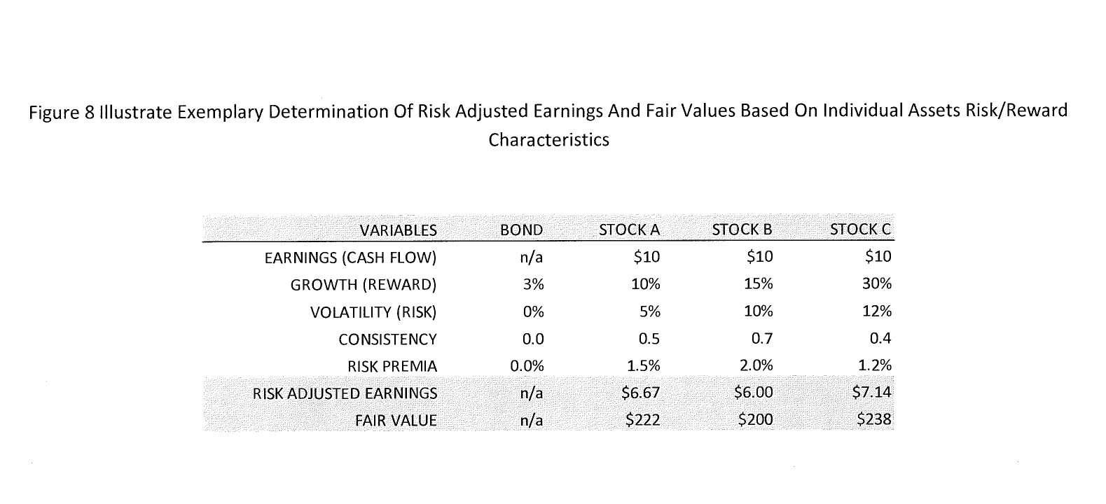

A risk adjustment may be calculated on a company's underlying fundamentals such as sales, earning, cash flow, dividends, book value or any other relevant fundamental measure. A risky assets fundamental metric, or a composite of a trailing average of fundamental metrics, measured over a period of time may be adjusted for volatility risk using the following equation:

$$Risk Adjusted Fundamental Metric = \frac{Fundamental {Metric}_{Ra}}{[ 1 + ( \frac{{σ}_{( μ ) Ra} - {σ}_{( μ ) Rfa}}{{μ}_{Ra}} ) ]}$$

Where Ra is a risky asset (stock), σ is the standard or semi variation of a fundamental metric for a risky asset over a period of time where μ may represent the growth rate or alternately the average value of a risky asset fundamental metric measured over a period of time. FIG. 8, illustrates risk adjusted earnings for three stocks (A-C) which has the same core earnings ($10) but with different risk/reward characteristics, i.e., different volatility and intrinsic growth rates. As can be seen, a stocks risk/reward characteristics have a significant impact in determining a fair value for risky assets, such as stocks.

A relative risk adjustment could alternately be calculated by subtracting a standard or semi deviation comparison of a fundamental metric by the trailing average of the fundamental metric for the same period or be calculated on a risky assets growth rate (intrinsic return rate) where risky assets growth rate is adjusted for relative volatility risk. The growth rate may be adjusted for volatility risk using the following equation:

$$Risk Adjusted Growth Rate = \frac{Growth Rate}{[ 1 + ( \frac{{σ}_{( μ ) Ra} - {σ}_{( μ ) Rfa}}{{μ}_{Ra}} ) ]}$$

Where Ra is a risky asset (stock), σ is the standard or semi variation of a growth rate for a risky asset over a period of time where μ represents the average or compounding growth rate measured over a period of time. Such risk adjustment is further illustrated in Table 1 that illustrates four risky assets (stock A-D) where the rewards (growth rates) are adjusted for relative volatility risk to the benchmark of a risk free asset (bond).

TABLE 1

| | BOND | STOCK A | STOCK B | STOCK C | STOCK D |
|---|---|---|---|---|---|
| REWARD (GROWTH) | 2.00% | 12.00% | 15.00% | 10.00% | 25.00% |
| RISK (VOLATILITY) | 0.00% | 5.00% | 5.00% | 45.00% | 20.00% |
| CONSISTENCY RATE | 0.00 | 0.42 | 0.33 | 4.50 | 0.80 |
| RISK ADJUSTED REWARD | | | | | |
| RISK ADJUSTED REWARD (GROWTH) | 2.00% | 8.47% | 11.25% | 1.82% | 13.89% |
| RISK (VOLATILITY) | 0.00% | 0.00% | 0.00% | 0.00% | 0.00% |
| CONSISTENCY RATE | 0.00 | 0.00 | 0.00 | 0.00 | 0.00 |

BOND = REPRESENTS THE RISK FREE RATE OF RETURN
REWARD = REPRESENTS YIELD TO MATURITY FOR BONDS AND INTRINSIC RETURN RATE FOR STOCKS
RISK = VOLATILITY MEASURED AS STANDARD OR SEMI DEVIATION OF REWARD (GROWTH)
CONSISTENCY RATE = RISK PER UNIT REWARD CALCULATED AS: REWARD/(1 + CONSISTENCY RATE)

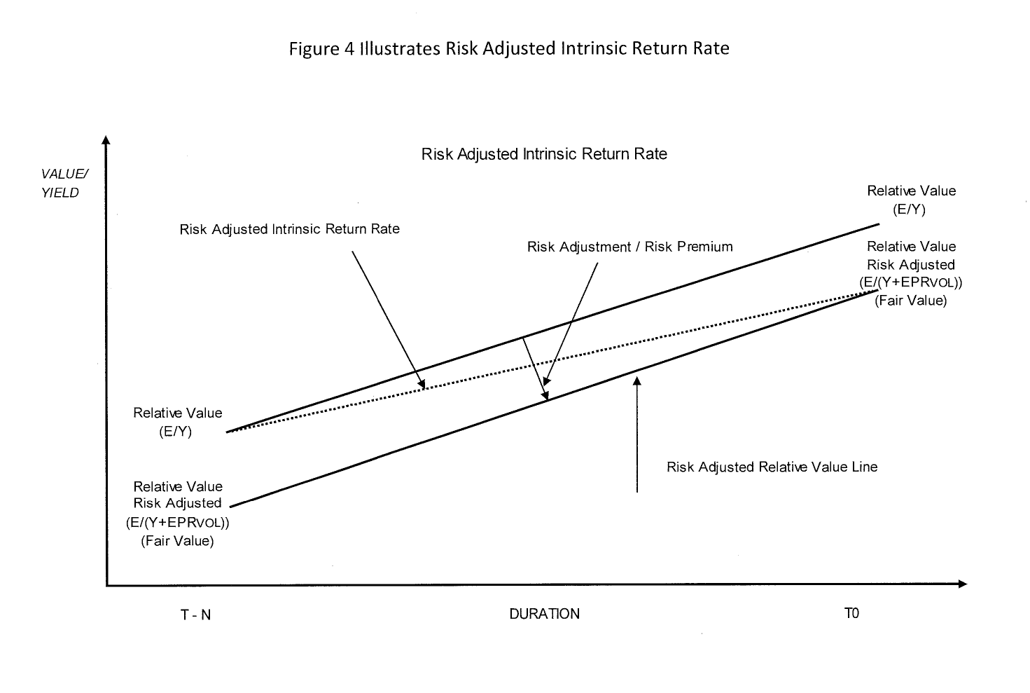

A risk adjusted intrinsic return (growth rate) is furthermore illustrated in FIG. 4, where a risk adjusted intrinsic return rate is determined between a historical relative value and a risk adjusted relative value at t₀

It should be noted that different formula can be used depending on application. For example, in some applications, it can be assumed that data are log-normally distributed (evidenced by the presence of skewness in the sampled data). In such cases, a more accurate estimate, derived from the properties of the log-normal distribution is defined as:

ĉᵥₗₙ=\sqrt{e^{sln}^{²}−1}

where sₗₙ is the sample standard deviation of the data after a natural log transformation. (In the event that measurements are recorded using any other logarithmic base, b, their standard deviation s_{b} is converted to base using sₗₙ=s_{b}ln(b), and the formula for remains the same). This estimate is sometimes referred to as the “geometric CV” in order to distinguish it from the simple estimate above. However, “geometric coefficient of variation” can be defined as:

GCV_{K}=e^{sln}−1

In statistics, dispersion denotes how stretched or squeezed a distribution (theoretical or that underlying a statistical sample) is. To the measure dispersion several alternative measures to standard or semi deviation could be used including, variance interquartile range, correlation coefficient, regression analysis, etc. Dispersion is interpreted as a measure of the degree of uncertainty, and thus risk, associated with a particular stock or investment portfolio.

A risky assets intrinsic return rate is defined as growth in a fundamental metric over a period of time. The calculation of intrinsic return may be based on a company's book value, sales, earnings or cash flow and may include distributions such as dividends. Furthermore, an intrinsic return may be calculated on a composite of fundamental metrics. The intrinsic return may also be based on a risky assets return on equity (ROE) or alternative profitability measures.

The intrinsic return rate may be calculated as: a compounded annual rate (CAGR), a mean rate, a median rate or a mode rate.

A fundamental metric is defined as parameters or measures of quantitative assessment used for measurement, comparison or to track performance. Fundamental metrics may refer to a company's EBITDA, earnings per share, book value or any other financial measures. Taking the ratios of some metrics forms multiples, which further allows for comparison of diverse companies.

A composite of fundamental metrics refers to two or more fundamental metrics that are combined. A composite fundamental metric may be an equally weighted average of a company's earnings, cash flow and dividends.

A fundamental metric comprises accounting based data found within a generally accepted accounting principles (GAAP) company income statement, balance sheet, cash flow statement, related financial ratios and accounts (GAAP reports).

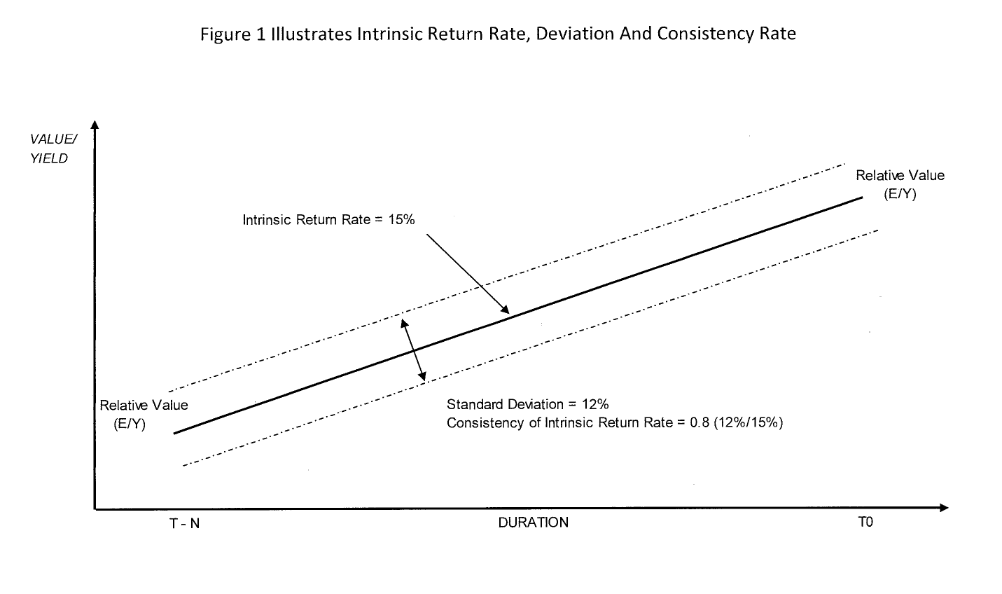

A risky assets consistency rate of intrinsic return rate may be determined by dividing a standard or semi deviation measure for the intrinsic return rate by the average or compounding intrinsic return rate over a period of time. FIG. 1, illustrates intrinsic return rate, deviation and consistency rate for a hypothetical stock.

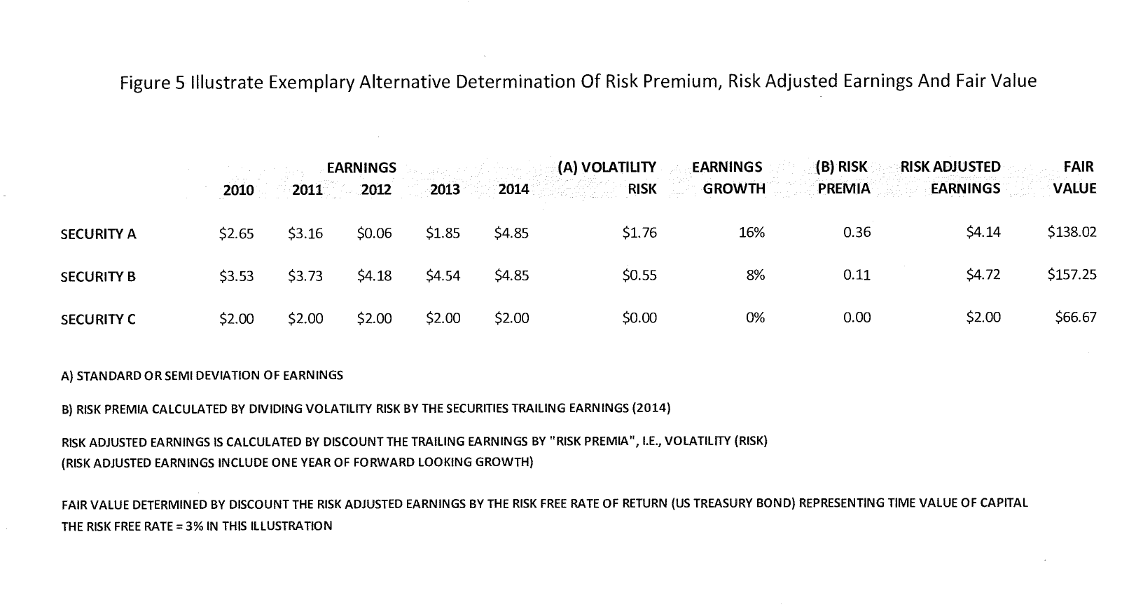

A consistency rate for risky assets could alternatively be determined by a measure of standard or semi deviation of a fundamental metric over a period of time and where the standard or semi deviation of the fundamental metric is divided by the fundamental metric normalized or trailing average data over a period of time or alternatively by the most recent reported data. FIG. 5, illustrates a risk premium (B) calculated as the standard deviation of earnings (volatility) for the period 2010-2014 divided by the most recent reported earnings (2014), $1.76/$4.85=0.36.

A measure of market risk exposure (or systematic risk exposure) may be calculated by dividing a consistency rate by an annual expected return on investment for individual or a pool of risky assets.

One could argue that a general equity risk premium would be desired in the calculation of a risky asset overall risk premium. This is particular true when we dealing with short time horizons. In such a scenario the risk free rate would be, for example, a short term Treasury bill which normally is associated with rates significantly lower than for longer time horizons. In such cases a general equity risk premium may be added to the asset specific risk premium. Where, GRP represents a general risk premium, or equity risk premium, which is common for all risky assets. The equity risk premium may be determined as the long term differential between the return for stock to the return for a risk free asset. A general equity risk premium may alternatively be determined through the deviation of intrinsic return for a pool of risky assets relative a benchmark of a risk free asset.

$$Risk Premium = Rfr \times [ \frac{{σ}_{( μ ) Ra} - {σ}_{Rfr}}{{μ}_{Ra}} ] + Grp + Ds$$

Furthermore, when considering the default risk for a particular risky asset an additional premium representing the default spread using credit agencies rating estimates may be added to account for default risk. The risk premium for a risky asset could be expressed as follows, where Ds represent a default spread for a risky asset.

In regard to the measurement of dispersion, a semi-deviation measure for a relevant time period may be appropriate as a proxy for risk. Semi deviation, also known as downside deviation, is a measure of downside risk that focuses on returns that fall below an average value or average expected return.

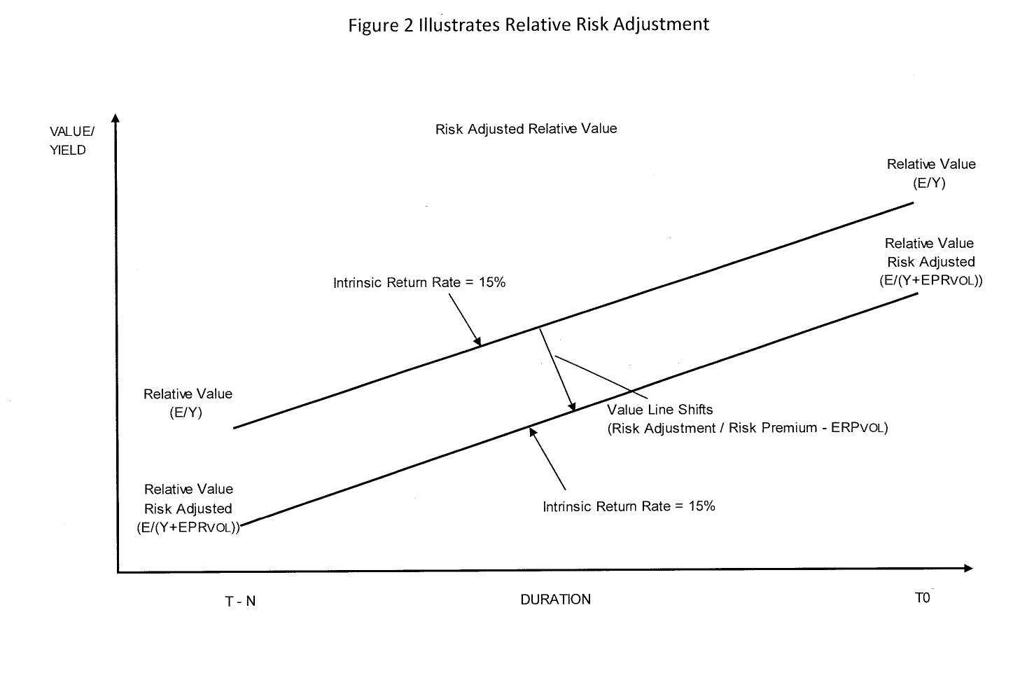

A risk adjusted relative value “fair value” for a risky asset to a risk free asset may be determined by dividing a risk adjusted fundamental metric, or a composite of risk adjusted fundamental metrics, with a risk free assets rate of return. FIG. 2. Illustrates a demonstrated risk adjusted fair values and the intrinsic return rate for a hypothetical stock. Note that the risk free rate (Y), represented by its present yield at to, is used as a constant discount rate when determine past relative values. The risk premium that is used to calculate the risk adjusted relative value is also a constant throughout the measurement period, i.e., determined at t₀. The risk premium is based on individual stocks earnings volatility which may differ significantly across individual stocks. Demonstrated volatility can be views as a measure of implied volatility.

Alternatively, the risky assets fundamental metric may be adjusted for volatility risk without consideration to the risk free rate. This is calculated by dividing the fundamental metric by (1+consistency rate), where (1+consistency rate) constitutes the discount factor.

Making an adjustment for relative volatility risk across asset classes allows for a coherent cross sectional analysis of risky assets (stocks) to the benchmark of risk free assets (bonds) in assessing fair values for risky assets.

A consistency rate may also be referred to as a consistency ratio in various embodiments in this application.

A risk adjusted relative value for a risky asset may also be termed a “fair” or “intrinsic” value in this application.

The term intrinsic return rate may also in this application be referred to as an intrinsic growth rate, a fundamental growth rate or a growth rate of a fundamental metric.

The term “intrinsic” refers to information such as financial data and performance related data pertaining to and issued by a company as opposed to data and information generated by the market.

A fair value for a company may be calculated by dividing a risk adjusted fundamental metric such as for example a stocks earnings by the risk free rate or alternately by dividing the fundamental metric by a discount rate including 1) a risk fee rate and 2) a risk premium compensating for volatility risk.

A fundamental metric is accounting based data and should not be confused with the terms “intrinsic” and/or “fair” value.

A noisy market hypothesis contrasts the efficient-market hypothesis in that it claims that the prices of securities are not always the best estimate of the true underlying value of the firm. It argues that prices can be influenced by speculators and momentum traders, as well as by insiders and institutions that often buy and sell stocks for reasons unrelated to fundamental value, such as for diversification, liquidity and taxes. These temporary shocks referred to as “noise” can obscure the true value of securities and may result in mispricing of these securities for many years.

Dividends and distributions are defined as regular dividends of cash and special distributions, which may consist of stock or other assets, paid by a company to its shareholders. It may also include indirect distributions such as repurchase of outstanding shares by a company in order to reduce the number of shares in the market to the benefit of shareholders value.

Profitability measures is a class of financial metrics that are used to assess a business's ability to generate earnings as compared to its assets, expenses and other relevant costs incurred during a specific period of time. Examples of profitability measures are profit margin, return on assets, return on equity and return on capital employed.

A future fair value for a stock may be calculated by capitalizing a current fair value with its demonstrated intrinsic return rate to a point in time in the future. Such calculation may simply provide for a forward looking fair value for a stock. A future fair value is calculated by multiplying the current fair value with ((1+intrinsic return rate)̂number of periods).

A fair value for a stock may be subtracted from its stocks market value to determine an investment margin. Such investment margin could be both positive and negative.

An expected return on investment (expected ROI) may be determined by dividing the fair value by the stocks market value. The investment margin is in this case calculated in relative terms. It is contemplated that an expected return on investment for a stock may be either positive or negative.

In this application (t₀) represent present time; (t−ₙ) is a point in time in the past; (tₙ) is a point in time in the future.

### Example Embodiments I

A risky assets (stocks) cash-flow is set in “volatility risk equilibrium” with a risk free assets cash flow (bond) when relative volatility risk has been considered and eliminated through a risk adjustment. In other words, a risk premium is added to the risk free rate to compensate for inconsistency (deviation or volatility) risk carried by the risky asset. This can be formulized as, E_{RA}Y_{RFA}+ERP_{VOL}), where E represents a risky assets (RA) earnings and Y represents the yield for a risk free asset (RFA) and where EPR_{VOL} represents the risk premium based on earnings volatility risk.

A risky asset (stock) is fair valued when the risky assets risk adjusted relative value to a risk free asset (bond) is in equilibrium with the risky assets (stocks) market value.

Equilibrium can be formulated as E_{RA}/(Y_{B}+ERP_{VOL})=P, where E_{RA} is the risky assets (stock) earnings and Y_{B} represents the yield for a risk free asset, and where ERP_{VOL} represents the risk premium based on demonstrated earnings volatility and where P represents the price or market value for the risky asset (stock).

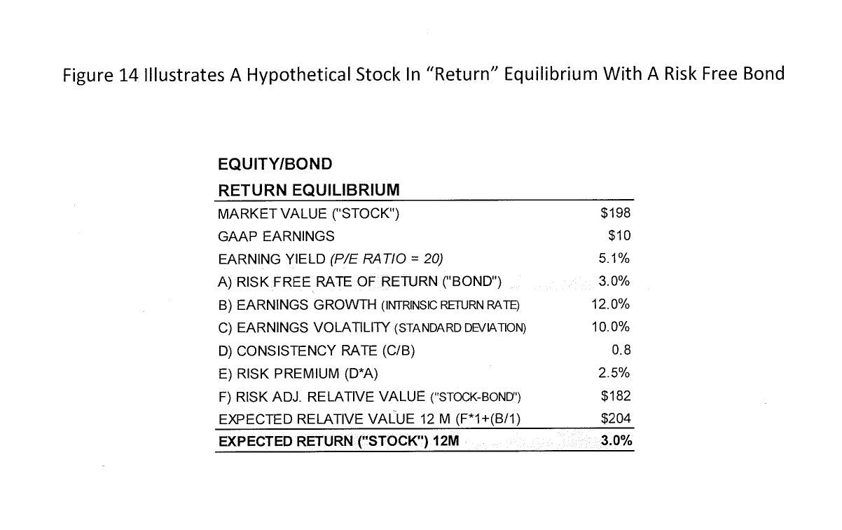

Return equilibrium is illustration in FIG. 14, where the price (stocks market value) for a hypothetical stock is calculated to $198 to yield an equal return as the risk free asset (bond), i.e., where the stock and the bond are expects to yield a similar or equal return of 3%. The stocks risk adjusted relative value “fair value” to the bond is calculated to $182. The fair value is calculated by dividing the GAAP earnings ($10) by the total discount rate of 5.5%. Where the discount rate consists of both the risk free rate and a risk premium compensating for relative volatility risk.

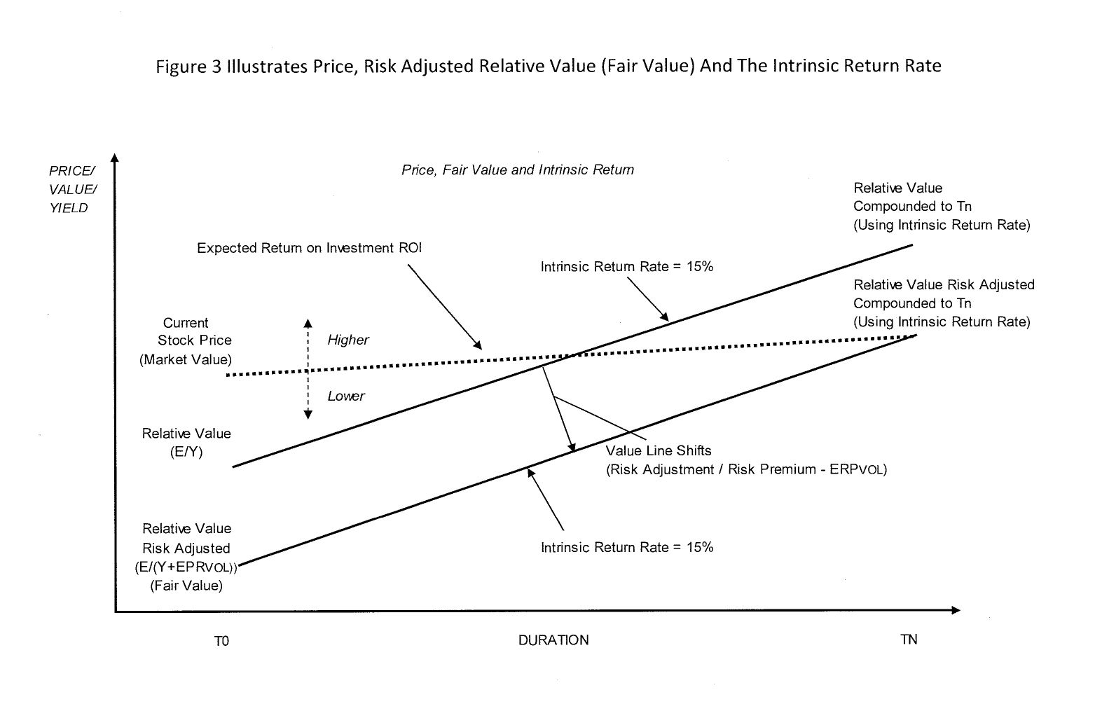

An expected return on investment (expected ROI) may be determined by dividing a fair value by a stock's current market value. The expected return on investment may be calculated by a compounding return determined between a forward looking fair value and a current market value. FIG. 3, illustrates an expected return on investment measured as the rate of return between a stocks forward looking risk adjusted relative value (fair value) and its current stock price and where a higher stock price would generate a lower expected return on investment and conversely a lower stock price would generate a higher expected return on investment, ceteris paribus.

In one advantageous embodiment a system for portfolio construction and indexation of a plurality of stocks in a subject investment portfolio is provided where the system comprises an associated storage medium (memory) and a computer connected to a network. The computer receives real time data associated with the plurality of stocks and bonds, and the storage medium connected to the computer has instructions or programs stored thereon. The computer executes the program and implements operations that simultaneously index the stocks by: a. determining a value for each of the plurality of stocks at time (t₀) by calculating a relative value by dividing a stocks Earnings Per Share (EPS) by a Risk Free Rate at time (t₀), where time (t₀) is the present time; b. calculating an intrinsic return for each of the plurality of stocks for a period of time (t₀-t−ₙ), by dividing the value of the stock at time (t₀) by the calculated value at time (t−ₙ), where time (t−ₙ) is a point in time in the past, such that the intrinsic return is calculated exclusive of a price of the stock; c. determining a consistency of intrinsic return rate for each of the plurality of stocks by calculating a deviation of returns for periodically determined values for the period (t₀-t−ₙ), and then dividing the deviation by the intrinsic return; d. calculating a discount rate at time (t₀) for each of the plurality of stocks by multiplying the consistency of intrinsic return rate by the Risk Free Rate at time (t₀) to generate a risk premium, and adding the risk premium to the Risk Free Rate at time (t₀); e. generating a risk adjusted value at time (t₀) for each of the plurality of stocks by dividing the earnings at (t₀) by the discount rate at (t₀); f. calculating a future value at time (tₙ) for each of the plurality of stocks by compounding the risk adjusted value at time (t₀) with the intrinsic return rate, where time (tₙ) is a point in time in the future; g. generating a risk adjusted expected rate of return on investment at time (t₀) for each of the plurality of stocks by dividing the future value at time (tₙ) by a price for the stock at time (t₀); and h. generating a portfolio index of stocks at time (t₀) based on the risk adjusted expected return on investment for each of the plurality of stocks. By generating and applying the portfolio index, the inventive system automatically adjusts (i.e., selects and weights, by indexation) the subject investment portfolio achieving enhanced, passive systematic management of the portfolio and securities therein.

In another advantageous embodiment a system for portfolio indexation of a plurality of securities is provided comprising: a computer operably coupled to a network, the computer receiving real time data associated with a plurality of stocks; and a storage medium operably coupled to said computer and having a program stored thereon. The program is implemented to simultaneously index the stocks by: a. selecting a fundamental metric for a stock at time (t₀); b. calculating an intrinsic growth rate at (t₀) of the fundamental metric for a period of time (t₀-t−ₙ); c. determining a deviation rate of the fundamental metric for the period of time (t₀-t−ₙ); d. calculating a consistency rate for the fundamental metric at time (t₀) by dividing the deviation rate of the fundamental metric at (t₀) by the fundamental metric at (t₀); e. calculating a risk adjusted fundamental metric by dividing the fundamental metric at (t₀) by (1+the consistency rate) at (t₀); and f. generating an index of a plurality of stocks at time (t₀) by weighting each of the plurality of stocks by its risk adjusted fundamental metric.

In an efficient market, stock prices would be determined primarily by fundamentals. An owner of a common stock has a claim on earnings, and earnings per share (EPS) are the owner's return on investment. When investors invest in stocks they are purchasing a proportional share of an entire future stream of earnings.

Part of these earnings may be distributed as dividends, while the remainder will be retained by the company (on investor's behalf) for reinvestment. The current value of a future earnings stream can be viewed as a function of the current level of earnings, the quality (volatility) of the earnings and the expected growth of the earnings.

Investors who buy assets have returns that they expect to make over the time horizon that they will hold the asset. The actual return that they make over this holding period may be different from the expected return. Risk is viewed in terms of the variance in actual return around the expected return. For an investment to be risk free, the actual return should be equal to the expected return. To illustrate, consider an investor with a one-year time horizon buying a one-year Treasury bill with a 1% expected return. At the end of the 1-year holding period, the actual return for the investor would be 1%, which is equal to the expected return.

An investment is risk free because there is no variance around the expected return. In this context, a risk free asset should have returns that are uncorrelated with risky assets. In other words, an asset that delivers the same return, no matter what the scenario, should be uncorrelated with risky assets with returns that vary across scenarios.

When a risk free asset is defined as one where we know the actual return with certainty, two basic conditions that have to be met: 1) there can be no default risk, and 2) for an investment to have an actual return equal to its expected return there can be no reinvestment risk.

Based on the requirements of no default risk and no reinvestment risk as prerequisites for an investment to be risk free, the risk free rates will vary with time horizon. Thus, we would use a one-year default free bond to derive the risk free rate for a one-year cash flow projection and a five-year default free bond to derive the risk free rate for a five year cash flow projection for a risky asset. In fact, a conventional five-year bond will not yield a risk free return over 5 years, even if it is issued by a default free entity, because the coupons every 6 months will have to be reinvested at uncertain rates.

Thus, the risk free rates for each period could be measured by using the rate on a zero-coupon default-free bond maturing in that period. In the United States, where zero coupon treasuries have been traded for several years now called, STRIPS.

Considering inflation risk, there have been few traded default-free securities that could be used to estimate real risk free rates, but the introduction of inflation-indexed treasuries has filled this void. An inflation-indexed Treasury security (TIPs) does not offer a guaranteed nominal return to buyers, but instead provides a guaranteed real return. Consequently, an inflation-indexed Treasury bond that offers a 2% real return, will yield approximately 3% in nominal terms if inflation is 1%. The difference between the nominal and the real treasury rate can be viewed as a market expectation of inflation. Alternately, the inflation-indexed treasury rate could be used as the real risk free rate in the United States.

The risk free rate is the building block for estimating both the cost of equity and cost of capital. The cost of equity is computed by adding a risk premium to the risk free rate, with the magnitude of the premium being determined by the risk in an investment and the overall equity risk premium (for investing in the average risk investment). The cost of debt is estimated by adding a default spread to the risk free rate, with the magnitude of the spread depending upon the credit risk in the company. Thus, using a higher risk free rate, holding all else constant, will increase discount rates and reduce present value in a discounted cash flow valuation.

Because of tax advantages on debt issuance, it will be cheaper to issue debt rather than new equity. At some point, however, the cost of issuing new debt will be greater than the cost of issuing new equity. This is because adding debt increases the default risk—and thus the interest rate that the company must pay in order to borrow money. By utilizing too much debt in its capital structure, increases the default risk which can drive up the costs for other sources (such as retained earnings and preferred stock). Management must identify the “optimal mix” of financing—the capital structure where the cost of capital is minimized so that the firm's value can be maximized. The structure of capital should be determined considering the weighted average cost of capital (WACC).

Furthermore, the capital structure substitution theory has challenged the definition of the risk free rate as securities issued by the government. The theory suggests that supply (company management), rather than demand (investors) drives the relationship between earnings yields, (E/P) and interest rates. Stock market earnings yield tends to equilibrium not with the government bond yield but with the average after-tax corporate bond yield as companies adjust capital structure (mix of equity and bonds) to maximize earnings per share. If managements consistently optimize capital structure by substituting stocks (repurchasing shares) for bonds or vice versa, equilibrium is reached when: E_Ra/P_Ra=R_(Ra [1−T]n), where E is the earnings-per-share, Ra is an risky asset, P is the share price, R is the nominal interest rate on corporate bonds and T is the corporate tax rate.

In general, the risk-free rate can be viewed as the theoretical rate of return of an investment with no risk of financial loss. One common interpretation is that the risk-free rate represents the interest that an investor would expect from an absolutely risk-free investment over a given period of time. Since the risk free rate can be obtained with no risk, it is implied that any additional risk taken by an investor should be rewarded with an interest rate higher than the risk- free rate.

Government bonds and corporate bonds generally have more moderate short-term price fluctuations than stocks, but provide lower potential long-term returns. U.S. Treasury Bills maintain a stable value if held to maturity, but returns are generally only slightly above the inflation rate.

In summary, for an investment to be risk free, it has to meet two conditions. The first is that there can be no risk of default associated with its cash flows. The second is that there can be no reinvestment risk in the investment. Using these criteria, the appropriate risk free rate to use to obtain expected returns could be a default-free zero coupon rate that is matched up to for the time horizon of when the cash flow or flows that are being discounted occur, i.e., match the duration of the risk free asset to the duration of the cash flows being analyzed for a risky asset. A default free government issued zero coupon securities rates as risk free rates or alternatively an inflation-indexed treasury rate could be used as the real risk free rate in the United States. Furthermore, cost of capital (WACC), or as the capital structure substitution theory suggests, a high grade corporate bond after-tax bond yield may be used as the appropriate proxy for the risk free rate.

Note that fixed income securities can be distinguished from inflation-indexed bonds, variable-interest rate notes, and the like. If an issuer misses a payment on a fixed income security, the issuer is in default, and depending on the relevant law and the structure of the security, the payees may be able to force the issuer into bankruptcy. In contrast, if a company misses a quarterly dividend to stock (non-fixed-income) shareholders, there is no violation of any payment covenant, and no default. However, some inflation—indexed bonds do have some variance, i.e., variable interest rate notes, which may be desired as the benchmark for a risk free asset.

In practice to work out the risk-free interest rate in a particular situation, a risk-free bond is usually chosen that is issued by a government or a corporate bond where the risks of default are so low as to be negligible.

Stocks are risky assets which have different risk/reward characteristics than a risk free asset (bond). Individual stocks may have risk/reward characteristics that is inherited in a particular business or industry.

The advantage of eliminating relative volatility risk across competing stocks to the benchmark of investable bonds is that it provides for a coherent cross sectional analysis of competitive investment returns across the asset classes, stocks and bond.

Furthermore, by eliminating relative volatility risk provides for an objective, systematic and coherent asset allocation process across the competing asset classes, stocks and bonds.

In portfolio construction there are generally two main considerations, a) the selection methodology and b) the weighting methodology. A portfolio index is typically selected from a universe of stocks. Such universe may consist of domestic and international developed or emerging markets. The universe may further consist of large, mid or small cap stocks.

Portfolio constituents may be weighted using particular weighting methodologies; such as (a) fundamental weighting (b) fair value weighting (c) relative value weighting or (d) through a synthesized value weighted system.

In a fundamentally weighted portfolio index constituents are weighted based on a risk adjusted fundamental metric as a measure of firm size. Alternately weights may be based on a composite of fundamental metrics such as, for example, on an equal weighted average of earnings, cash flow and dividends. A composite fundamental metric may be constructed as an equal weighted average of two or more fundamental metrics. A fundamentally weighted system avoids bias of underweight growth stocks and overweight highly volatile (risky) stocks.

In a fair value weighted portfolio stocks are weighted based on their risk adjusted relative value to bonds “fair value” as a measure of firm size. A fair value weighted portfolio avoids fundamentally weighted portfolio bias of underweighting growth stocks and overweighting stocks with high volatility risk.

A fair value weighted portfolio assign weights based on stocks risk adjusted relative value to the risk free rate. i.e., fair value can be expressed as, E/(Y+ERP_{VOL}). Where E represents Earnings, Y represents the risk free rate and ERP_{VOL} represents a risk premium based on earnings volatility.

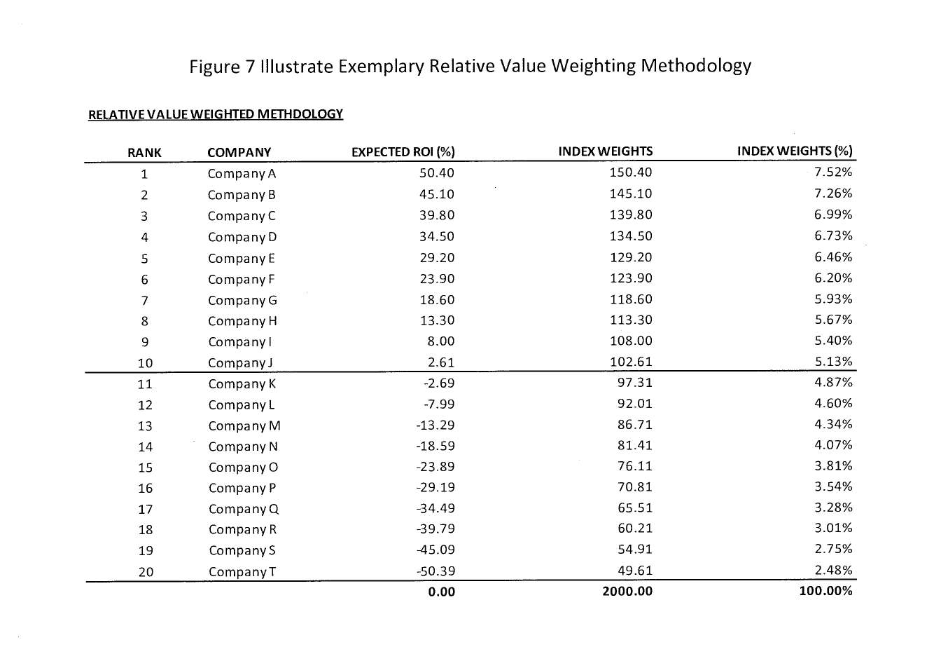

A relative value weighted system weights components based on their investment margin expressed as an expected rate of investment returns. The expected rate of investment return is calculated by dividing a stocks risk adjusted fair value by the current market value. Since expected returns can be both positive and negative a factor (100) is be added to the expected return rate to enable weighing of both positive and negative expected returns as illustrated in FIG. 7. In other words, the relative value weighted index expresses weights in relative terms as opposed to an absolute term, e.g., firm size. A relative value weighted portfolio avoids the concentration risk that is inherited in traditional market cap-weighted and fundamentally weighted indexes. Furthermore, a relative value weighted index will avoid bias in market cap weighted indexes of overweight overvalued stocks and underweight undervalued stocks. As illustrated in FIG. 7, a relative value weighted methodology overweight's undervalued stocks as measured by positive expected returns and underweight undervalued stocks as measured by negative expected returns (expected ROI).

A synthesized value weighted index is weighted on the difference (or margin) between a stocks fair value as a measure of firm size and its market value. Such synthesized system where the margin (or difference) between the intrinsic value and the market value is added to the intrinsic value is desired. A positive margin indicates an undervaluation and a negative margin indicated an overvaluation. Consequently, a synthesized weighting system will overweight undervalued stocks and underweight overvalued stocks.

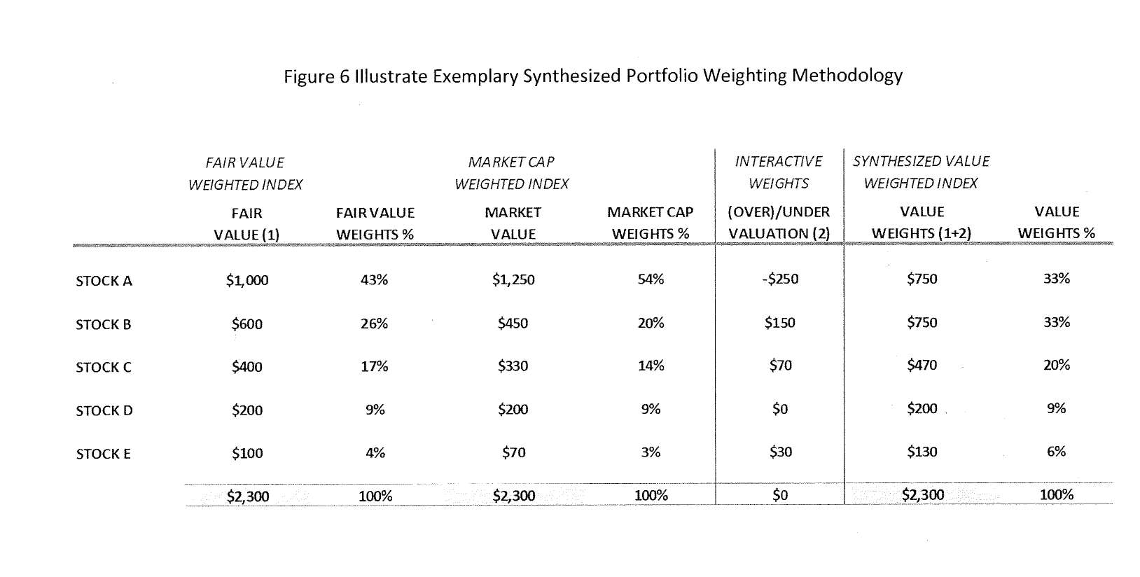

A synthesized value weighting system interact the fundamental value (as a measure of firm size) or fair value by a market value weight (stock market size of firm). In this weighting system the difference (or margin) between the fair value of a company and its market value is added to the fair value. The margin may be either positive (where the fair value exceeds the market value) or negative (where the market value exceeds the fair value). It is further contemplated that a positive margin indicate an undervaluation and a negative margin indicates an overvaluation. FIG. 6, illustrated an exemplary embodiment of the synthesized value weighted methodology.

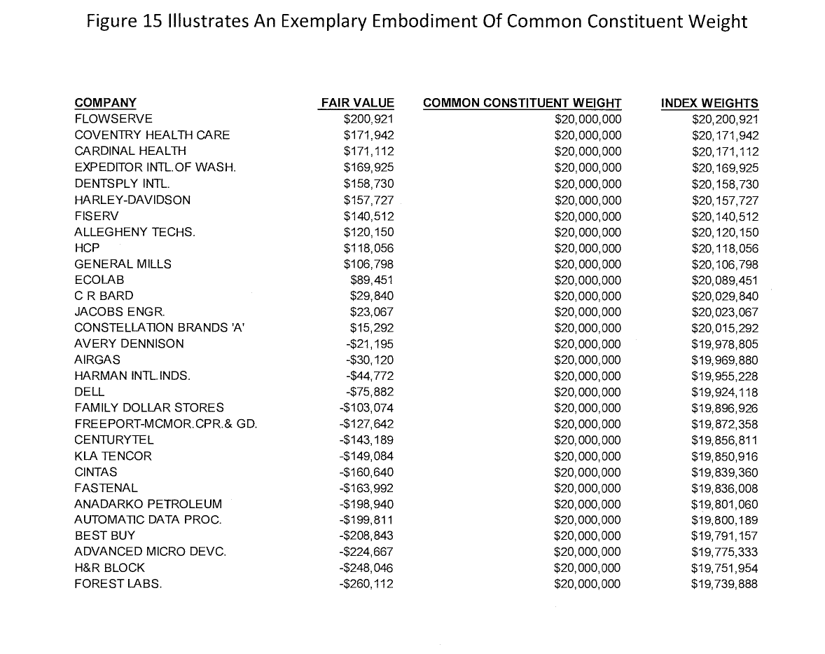

As discussed, when determining over and undervaluation for a plurality of securities in a portfolio it is contemplated that overvalued stocks have a negative expected return. Furthermore, it is contemplated when an investment margin is added to a fair value, may result be a negative value. That is since the market value may exceed a calculated fair value for the stock. To enable to assign weights to securities with negative values (or returns) a constituent common weight is added to rescale the weights. The constituent common weight may be of any quantity that exceeds a negative value, i.e., the most overvalued security. FIG. 7 illustrates an exemplary embodiment of a constituent common weight of “100” (referred to as index weights in FIG. 7) that is added to the expected return on investment (expected ROI). When assigning a common constituent weight in a synthesized weighed portfolio, where the portfolio is based on a measure of firm size, a constituent common weight system redistribute weights in order to reduce concentration risk. The greater the constituent common weights the more smoothing of the portfolio weights which in turn generate less concentration risks in a portfolio. Concentration risk may arise when portfolio weights are based on a measure or firm size (such as in a market capitalization weighted portfolio) and where a few large companies dominate a portfolio. FIG. 15 illustrates constituent common weights applied to a sub section of a hypothetical portfolio.

It is contemplated that a relative value and synthesized weighting system avoids biases in traditional market cap weighted and fundamentally weighted portfolios.

To illustrate, consider the stock price for a hypothetical stock within and portfolio index. In the case the price for a stock goes up (increase in value), the weight for that stock increase in a market cap weighted index, while the weight remains the same in a fundamentally weighted index and while the weight decrease in a relative value and synthesized weighting system, ceteris paribus. It is consequently contemplated that a relative value weighting and/or synthesized weighted system avoids bias inherited in a market cap weighted index of overweight overvalued stocks and underweight undervalued stocks.

Furthermore, a portfolio index may be weighted by one or more factors; such as for example a fair value; or a combination of fair value and return on equity which is a measure of profitability. Additionally, market “price” momentum and other factors may be added either in the selection or weighting process.

A relative value weighted portfolio index may further include bonds. Bonds are selected to match the expected returns for stocks. In other words, a portfolio index may include a plurality of investable bonds that meets a minimum threshold rate of expected investment returns. It is furthermore contemplated that bonds may replace stocks that have a negative expected return on investment (ROI). This can be intuitively illustrated in FIG. 7 where a portfolio would constitute a blend of stocks and bonds.

In a blend portfolio, stock and bond valuation dynamically interacts based on stock market valuation such as when valuation rises for stocks, i.e., expected ROI's decrease, more bonds qualifies for the portfolio and consequently when valuation drops less bonds qualifies since expected returns increase for stocks relative bonds. A blend equity/bond portfolio allows for a coherent asset allocation process across asset classes, stocks and bonds.

When bonds are included in a portfolio index it is understood that bonds expected return may be measured as a differential between its market price and its face value or alternately as the yield to maturity.

A portfolio index operates in real time, where a re-selection (adjustment) and/or re-weighting (rebalancing) occurs timely as fundamental factors and market factors change for stocks and bonds in the marketplace.

What is known is that conversional market cap weighted and price weighted indexes overvalues overvalued companies and undervalues undervalued companies. Both mathematically and empirically, this over and under weighting problem inherent to cap-weighting has been shown to generate a return drag of 200 bps per year in the U.S. and more in less efficient stock markets.

Conversional index methodologies build on traditional financial theories that assume equity markets to be efficient in accordance with the efficient market hypothesis (EMH). In efficient markets stock prices perfectly reflects the underlying value of the asset. Consequently security analysis is based on a single measurement, i.e., market value.

Should stock markets not be as efficient as previously assumed, additional factors have to be considered in order to determine a fair value for risky assets (stocks). Since it is arguably difficult to know the intrinsic value for stocks a more businesslike approach to valuation can be undertaken. Such approach should analyze both risk and reward factors in capital markets. The present invention introduces a coherent conceptual framework for portfolio construction and indexation in capital markets under a noisy market hyphotesis.

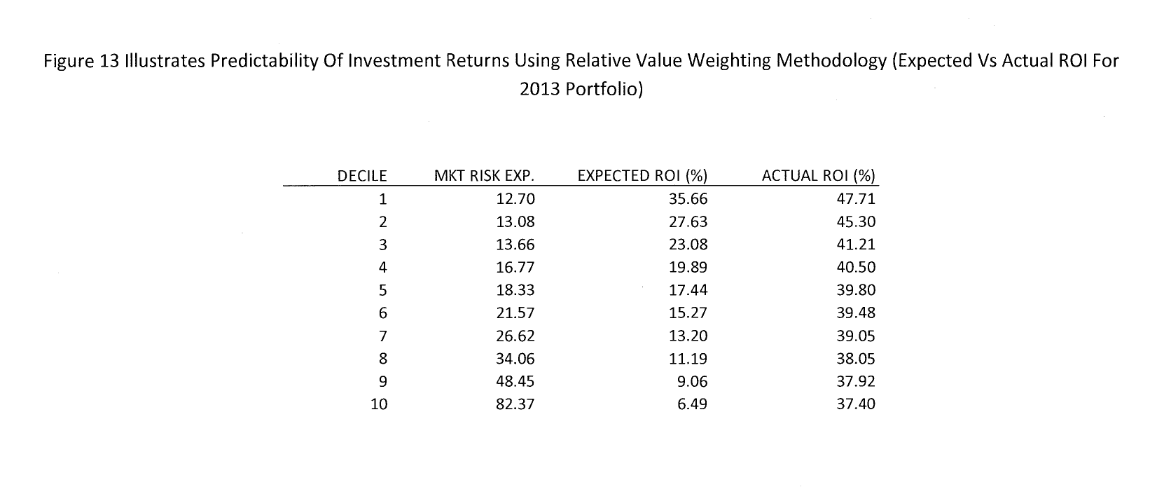

The claimed invention improves on explaining a fair value for risky assets over single factor market cap weighted and fundamentally weighted indexes. Furthermore, the claimed invention provide for increased predictability of both short and long term returns as illustrated in FIG. 13, where simulated performance shows strong correlation of expected and actual returns across deciles.

The claimed invention eliminate biases in fundamentally weighted portfolios by avoiding biases of underweighting growth stocks and overweight stocks with high volatility (low consistency stocks) and furthermore, and relative market cap weighted portfolios, eliminate biases of underweight undervalued stocks and overweight overvalued stocks. Additionally, the claimed invention reduces concentration risk inherited in market cap and fundamentally weighted portfolio indexes.

The various embodiments discussed herein overcome the shortcomings of traditional financial theories that are inherited in conventional market cap and price weighted indices.

### Example Embodiments II

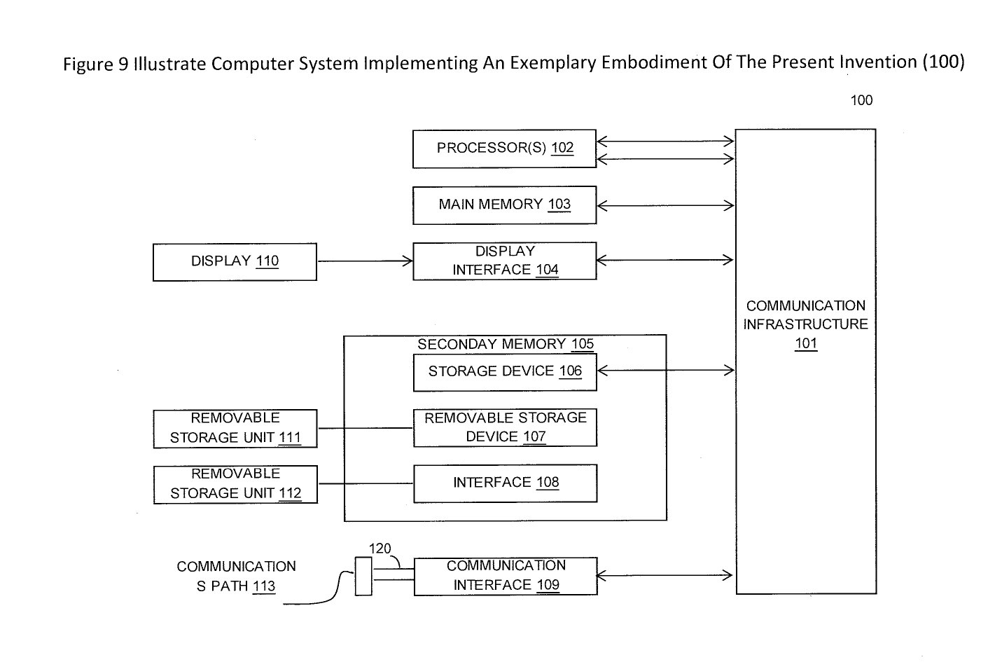

Provided herein is a system and method for determining profitability on stock investments. The method is generally described in an advantageous embodiment as provided below and further illustrated in FIGS. 1-3 and 5-8 while the system is generally illustrated and detailed in FIGS. 9-12.

The method may include four steps: 1) determining the fair value of a particular stock; 2) determining the annual compounding intrinsic return of the company; 3) determining the consistency of the intrinsic return; and 4) determining the current annual compounding rate of return on investment. Alternatively, it is contemplated that the step of determining consistency of the intrinsic growth may be performed during step 1, such that the step of determining a fair value of a particular stock takes into account the risk involved.

Primary Method, step one: Current Fair Value Determination. For this application, “fair value” is the relative value to the risk free rate of a Treasury Note. In one advantageous embodiment, the Treasury Note could be a ten-year note. For earnings, the previous year's Generally Accepted Accounting Principles (GAAP) earnings may be used. Alternatively, the consensus earnings estimate for the current year could be used.

$$Fair Value = \frac{Rolling EPS}{Last 5 Days Average Risk Free Rate} \qquad Equation 1$$

### Example

$$Hennes \& Mauritz = \frac{SEK 16.5}{4.7 \%} = SEK 351$$

The following example illustrates how to calculate the per share fair value of a company. In this example, the per share GAAP earnings is $10 and the current risk free ten-year government note rate is 5%. With these facts, the fair value is calculated to $200 or ($10 divided by 5%). If the fair value cannot be determined as the relative value to the risk free rate of a ten-year Treasury Note, then the last reported book value will be used as fair value. Alternatively, the consensus estimate for the book value may be used as the fair value.

Step two: Annual Compounding Intrinsic Return. This is determined, for example, by a historical annual compounding rate of return of a company's relative value to the risk free rate (e.g. a ten-year Treasury Note) taking dividends and other distributions into consideration. The risk free rate may be defined as the current rate or actual (historical rate) or alternatively the average rate during the period (e.g. past ten years). The relative value (fair value) is calculated by dividing the annual Earnings Per Share (EPS) with the risk free rate. Dividends or other distributions are the accumulated payments during the period (duration) extending from time t₀ to time t1−ₙ. The higher of the relative value to the risk free rate and the book value.

The annual Compounding Intrinsic Return=Future value (A) (fair value at time tₙ)+accumulated distributions including dividends Paid (B) divided by Present value (C)̂1/n−1 (fair value at time t₀).

$$Annual Compounding Intrinsic Return = {( \frac{Future Value + Accumulated Distributions}{Present Value} )}^{( 1 / n )} - 1 \qquad Equation 2$$

a) Future value =the company's historical relative value to the risk free rate (fair value) at the end of the measured period (year 10).

b) Accumulated distributions =the sum of dividend payments and other distributions during the period (10 years)

c) Present value=the company's historical relative value to the risk free rate (fair value) at the beginning of the measured period (year 1).

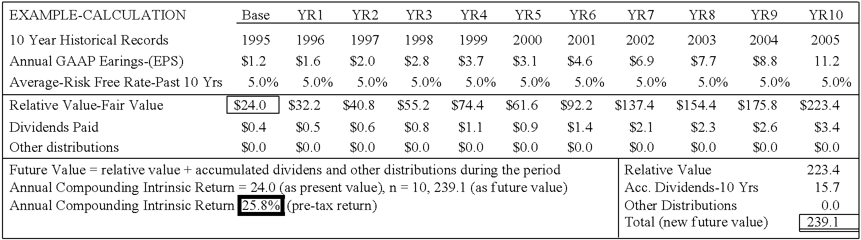

It is contemplated that if fair value cannot be determined as the relative value to a risk free rate, the last reported book value may be used as the fair value. If fair value (e.g. the relative value) is lower than book value, the book value will be used as fair value when determining the annual compounding intrinsic return. For example, fair value is the higher of the relative value to the risk free rate and the book value. Alternatively the consensus estimate for book value may be used as the fair value.

Further analysis could also be performed through, for example, ten, five and two year periods on the annual compounding intrinsic return to indicate if the return is increasing or decreasing. The book value, dividend, cash flow, return on equity or on total capital could alternatively be used when determining intrinsic return.

Still further, a weighing system could be applied to normalize earning by taking into account cyclical ups and downs in the business (economy) cycle.

Step three: Consistency of Intrinsic Return. This step if defined and determined by the consistency ratio of the historical annual compounding intrinsic return (e.g. the standard deviatio—which is calculated through the year by year growth records of the relative value to the risk free rate (intrinsic return)—divided by, for example, the ten-year historical annual compounding intrinsic return). The consistency ratio is calculated to get a measure of relative risk.

$$Consistency = \frac{\begin{matrix}Standard Deviation of 10 Yr ( Year by Year Growth \\ Records ) of the Relative Value to the Risk Free Rate\end{matrix}}{10 Y r Annual Compounding Intrinsic Return} \qquad Equation 3$$

### Example

$$Hennes \& Mauritz = \frac{20.9 \%}{26.5 \%} = 0.79$$

It should be noted that a higher consistency ratio translates to higher risk and vice versa. A rating system is used to classify stocks by risk. For example, a low consistency ratio translates to high predictability and therefore, a high rating. Whereas a high variation translates to low predictability and therefore, a relatively low rating. It is contemplated that additional consistency analysis may be performed through the ten, five and two year compounding return, which indicates if the consistency ratio is increasing or declining. Alternatively, other alternative measurements could be used to account for risk.

Step four: Current Annual Compounding Rate of Return on Investment. This is determined by calculating the annual compounding rate of return between a current stock price and a calculated future value (fair value at time tₙ). The calculated future value may be calculated over a specified period of time, such as, for example, ten years.

$$Current ROI = {( \frac{Future Value}{Current Price} )}^{( 1 / n )} - 1 \qquad Equation 4$$

In one example, to determine the short term fair value of a stock it is assumed to be $200 (fair value at time t₀), and a ten-year annual compounding intrinsic return is assumed to be 15% for ten years. The future value (fair value at time tₙ) is then calculated to be $808. If the current stock price, which is determined by the stock market, is $150, then the current annual return on investment is 18%. This is calculated by taking $150 as the present value, the duration of ten years, and the future value of $808. If, however, the stock price was higher, e.g. $300, the current annual compounding return on investment would be lower, calculated to 10%.

An alternative step one may be used where risk, based on the coefficient of risk, may be initially taken into account during the first step of determining a fair value for the stock.

First alternative to the primary method, step one: Fair Value Determination Taking into Account Risk. The step is similar to Step one as described above, except that risk (volatility) is taken into consideration during step one of determining fair value of a stock rather than waiting till step three.

The new risk adjusted required initial return or discount rate, is determined by a Consistency Ratio between a standard deviation and an intrinsic return. The standard deviation of historical performance (e.g. intrinsic return) is divided by the historical intrinsic return and multiplied with the risk free rate plus the risk free rate.

$$Required Initial Return = \frac{\begin{matrix}Standard Deviation of 10 Yr ( Year by Year Growth \\ Records ) of the Relative Value to the Risk Free Rate\end{matrix}}{10 Y r Annual Compounding Intrinsic Return} \times Risk Free Rate + Risk Free Rate \\ Risk Premium = Required Initial Return - Risk Free Rate \qquad Equation 5$$

### Example

$$Required Initial Return = ( \frac{20.9 \%}{26.5 \%} ) \times 4.7 \% + 4.7 \% = 8.4 \%$$

$$Risk Premium = 8.4 \% - 4.7 \% = 3.7 \%$$

For example, a standard deviation is 10%, the intrinsic return is 20% and the risk free rate is 5%. The new discount rate or initial return requirement is therefore: (0.5*5%)+5%=7.5% (risk premium is 2.5%). If a company's last reported or trailing Earnings Per Share (EPS) is $10, then the new (risk adjusted) fair value would be $10 divided by 7.5% =$133. It can be seen that the new fair value is now discounted to reflect a 100% consistent (e.g. standard deviation=0) performance record. By calculating and adding a risk premium it becomes possible to compare companies in a population on a risk adjusted basis. This makes stocks comparable to a benchmark e.g. the (risk free rate), which has a standard deviation of “0” when held to maturity. Risk is the volatility in the year by year growth records of the intrinsic return.

It should be noted, however, that other alternative measurements and adjustments could be used or applied to calculate or estimate an appropriate risk premium or required initial return as desired. For example, regression analysis may be used to benchmark performance (e.g. bond market) or some other alternative methods may also be used.

In the alternative method, the second step of determining annual compounding intrinsic return is the same as described above and the third step of determining consistency of intrinsic return has already been accomplished in alternative step one.

In this alternative embodiment, an example is provided below for determining current annual compounding rate of return on investment.

For example, fair value is assumed to be $160, and the ten-year annual compounding intrinsic growth rate B is assumed to be 15% for ten years. The future value is then calculated to $646. If the current stock price, which is determined by the stock market, is $100, then the current annual return on investment is 21%. This is calculated by taking $160 as the present value, the duration of ten years, and the future value of $646. If the stock price is higher, such as for example $200, the current annual return on investment is lower, calculated to be 12%. If the fair value for the stock, e.g. $160 is paid, the current annual return on investment becomes 15%, e.g. the same return as the company performed intrinsically, e.g. intrinsic return

Second alternative to the primary method. The annual compounding intrinsic return is determined by adjusting the annual compounding intrinsic return for the relative risk calculated by the first alternative method. The new adjusted annual compounding intrinsic return is calculated by using A) the fair value according to the primary method and B) the future value according to first alternative method.

This second alternative method is another method of adjusting for relative risk. Instead of adjusting fair value (adding a risk premium) according to the first alternative method, the intrinsic return is adjusted and uses the same fair value as per the primary method. It should be noted that the end result is the same as using the first alternative method. One advantage of this method sequencing, however, is that the system could use the same fair value determination as the primary method.

It should be noted that, while various functions and methods have been described and presented in a sequence of steps, the sequence has been provided merely as an illustration of one advantageous embodiment, and that it is not necessary to perform these functions in the specific order illustrated. It is further contemplated that any of these steps may be moved and/or combined relative to any of the other steps. In addition, it is still further contemplated that it may be advantageous, depending upon the application, to utilize all or any portion of the functions described herein.

It is additionally contemplated that a method for determining the fair value of stocks in a population (e.g. an index), may be based on a ranking system generated by a computer that calculates the top ranked company based on its current annual compounding rate of return on investment according to the method described.

It is contemplated that the company with the highest current annual compounding rate of return on investment will, at any given moment, be the top ranked company in the index.

When all the companies have been ranked according to their current annual compounding rate of return on investment, it is contemplated that the fair value for the remaining companies may then be adjusted or recalculated and where a portfolio is automatically adjusted for enhanced passive systematic management of the securities therein.

The top ranked company, e.g. the company that has the highest current annual compounding rate of return on investment, may be used to adjust or determine the fair value for the remaining companies in real time to provide the most accurate and up to date information. The fair value may be determined by adjusting the fair value to yield a similar or competitive current annual compounding rate of return on investment as the number one ranked company. This is realistically taken into account because all investments compete with the rate of return on a risk free investment (e.g. a benchmark) and all investments compete with one another.

Although the invention has been described with reference to a particular arrangement of parts, features and the like, these are not intended to exhaust all possible arrangements or features, and indeed many other modifications and variations will be ascertainable to those of skill in the art.

It should be noted that, while various functions, systems and methods have been described and presented in a sequence of steps, the sequence has been provided merely as an illustration of one advantageous embodiment, and that it is not necessary to perform these functions in the specific order illustrated. It is further contemplated that any of these steps may be moved and/or combined relative to any of the other steps. In addition, it is still further contemplated that it may be advantageous, depending upon the application, to utilize all or any portion of the functions described herein. While embodiments of the present invention have been described herein for purposes of illustration, modifications and changes will become apparent to those skilled in the art. Accordingly, the appended claims are not intended to encompass all such modifications and changes as fall within the true spirit and scope of this invention.

### Exemplary Computer System Embodiments

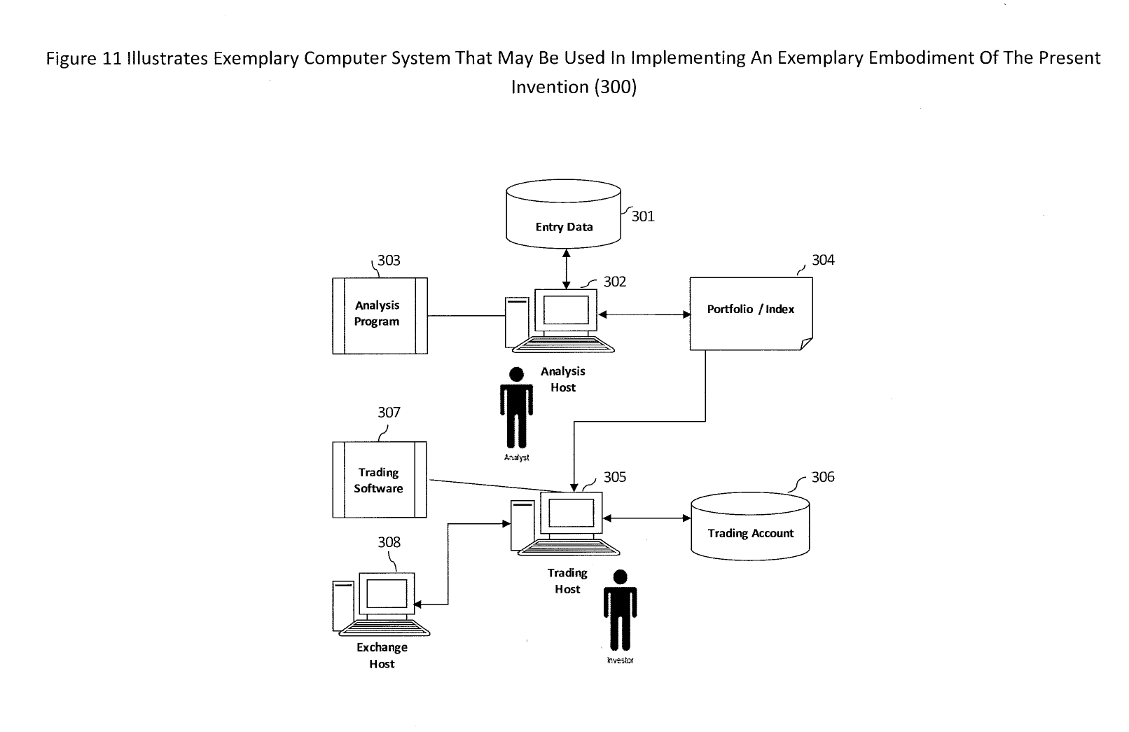

FIG. 11 illustrates an exemplary computer system that may be used in implementing an exemplary embodiment of the present invention. Specifically, FIG. 9 illustrates an exemplary embodiment of a computer system 100 that may be used in computing devices such as, e.g., but not limited to, a client and/or a server, etc., according to an exemplary embodiment of the present invention. FIG. 11 illustrates an exemplary embodiment of a computer system that may be used as client device 100, or a server device 100, etc. The present invention (or any part(s) or function(s) thereof may be implemented using hardware, software, firmware, or a combination thereof and may be implemented in one or more computer systems or other processing systems. In fact, in one exemplary embodiment, the invention may be directed toward one or more computer systems capable of carrying out the functionality described herein. An example of a computer system 100 may be shown in FIG. 11, depicting an exemplary embodiment of a block diagram of an exemplary computer system useful for implementing the present invention. Specifically, FIG. 11 illustrates an example computer 100, which in an exemplary embodiment may be, e.g., (but not limited to) a personal computer (PC) system running an operating system such as, e.g., (but not limited to) MICROSOFT®. WINDOWS®NT/98/2000/XP/CE/MENISTA, etc. available from MICROSOFT®. Corporation of Redmond, Wash., U.S.A. However, the invention may not be limited to these platforms. Instead, the invention may be implemented on any appropriate computer system running any appropriate operating system.

In one exemplary embodiment, the present invention may be implemented on a computer system operating as discussed herein. An exemplary computer system, computer 100 may be shown in FIG. 11. Other components of the invention, such as, e.g., (but not limited to) a computing device, a communications device, mobile phone, a telephony device, a telephone, a personal digital assistant (PDA), a personal computer (PC), a handheld PC, an interactive television (iTV), a digital video recorder (DVD), client workstations, thin clients, thick clients, proxy servers, network communication servers, remote access devices, client computers, server computers, routers, web servers, data, media, audio, video, telephony or streaming technology servers, etc., may also be implemented using a computer such as that shown in FIG. 11. Services may be provided on demand using, e.g., but not limited to, an interactive television (iTV), a video on demand system (VOD), and via a digital video recorder (DVR), or other on demand viewing system.

The computer system 100 may include one or more processors, such as, e.g., but not limited to, processor(s) 102. The processor(s) 102 may be connected to a communication infrastructure 101 (e.g., but not limited to, a communications bus, cross-over bar, or network, etc.). Various exemplary software embodiments may be described in terms of this exemplary computer system. After reading this description, it may become apparent to a person skilled in the relevant art(s) how to implement the invention using other computer systems and/or architectures.

Computer system 100 may include a display interface 104 that may forward, e.g., but not limited to, graphics, text, and other data, etc., from the communication infrastructure 101 (or from a frame buffer, etc., not shown) for display on the display unit 110.

The computer system 100 may also include, e.g., but may not be limited to, a main memory 103, random access memory (RAM), and a secondary memory 105, etc. The secondary memory 105 may include, for example, (but not limited to) a hard disk drive 106 and/or a removable storage drive 107, representing a floppy diskette drive, a magnetic tape drive, an optical disk drive, a compact disk drive CD-ROM, etc. The removable storage drive 107 may, e.g., but not limited to, read from and/or write to a removable storage unit (111) in a well-known manner. Removable storage unit 111, also called a program storage device or a computer program product, may represent, e.g., but not limited to, a floppy disk, magnetic tape, optical disk, compact disk, etc. which may be read from and written to by removable storage drive 107. As may be appreciated, the removable storage unit 111 may include a computer usable storage medium having stored therein computer software and/or data. In some embodiments, a “machine-accessible medium” may refer to any storage device used for storing data accessible by a computer. Examples of a machine-accessible medium may include, e.g., but not limited to: a magnetic hard disk; a floppy disk; an optical disk, like a compact disk read-only memory (CD-ROM) or a digital versatile disk (DVD); a magnetic tape; and/or a memory chip, etc.

In alternative exemplary embodiments, secondary memory 105 may include other similar devices for allowing computer programs or other instructions to be loaded into computer system 100. Such devices may include, for example, a removable storage unit 112 and an interface 108. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 112 and interfaces 108, which may allow software and data to be transferred from the removable storage unit 112 to computer system 100.

Computer 100 may also include an input device 140 such as, e.g., (but not limited to) a mouse or other pointing device such as a digitizer, and a keyboard or other data entry device (not shown).

Computer 100 may also include output devices, such as, e.g., (but not limited to) display 110, and display interface 104. Computer 100 may include input/output (I/O) devices such as, e.g., (but not limited to) communications interface 109, cable 120 and communications path 113, etc. These devices may include, e.g., but not limited to, a network interface card, and modems (neither are labeled). Communications interface 109 may allow software and data to be transferred between computer system 100 and external devices.

In this document, the terms “computer program medium” and “computer readable medium” may be used to generally refer to media such as, e.g., but not limited to removable storage drive 107, a hard disk installed in hard disk drive 106, and signals 120, etc. These computer program products may provide software to computer system 100. The invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms may be not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm may be here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it may be appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

In yet another exemplary embodiment, the invention may be implemented using a combination of any of, e.g., but not limited to, hardware, firmware and software, etc.

In one or more embodiments, the present embodiments are embodied in machine- executable instructions. The instructions can be used to cause a processing device, for example a general-purpose or special-purpose processor, which is programmed with the instructions, to perform the steps of the present invention. Alternatively, the steps of the present invention can be performed by specific hardware components that contain hardwired logic for performing the steps, or by any combination of programmed computer components and custom hardware components. For example, the present invention can be provided as a computer program product, as outlined above. In this environment, the embodiments can include a machine-readable medium having instructions stored on it. The instructions can be used to program any processor or processors (or other electronic devices) to perform a process or method according to the present exemplary embodiments. In addition, the present invention can also be downloaded and stored on a computer program product. Here, the program can be transferred from a remote computer (e.g., a server) to a requesting computer (e.g., a client) by way of data signals embodied in a carrier wave or other propagation medium via a communication link (e.g., a modem or network connection) and ultimately such signals may be stored on the computer systems for subsequent execution).

### Exemplary Communications Embodiments

In one or more embodiments, the present embodiments are practiced in the environment of a computer network or networks. The network can include a private network, or a public network (for example the Internet, as described below), or a combination of both. The network includes hardware, software, or a combination of both.

From a telecommunications-oriented view, the network can be described as a set of hardware nodes interconnected by a communications facility, with one or more processes (hardware, software, or a combination thereof) functioning at each such node. The processes can inter-communicate and exchange information with one another via communication pathways between them called interprocess communication pathways.

On these pathways, appropriate communications protocols are used. The distinction between hardware and software may not be easily defined, with the same or similar functions capable of being performed with use of either, or alternatives.

An exemplary computer and/or telecommunications network environment in accordance with the present embodiments may include node, which include may hardware, software, or a combination of hardware and software. The nodes may be interconnected via a communications network. Each node may include one or more processes, executable by processors incorporated into the nodes. A single process may be run by multiple processors, or multiple processes may be run by a single processor, for example. Additionally, each of the nodes may provide an interface point between network and the outside world, and may incorporate a collection of sub-networks.

As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently.

In an exemplary embodiment, the processes may communicate with one another through interprocess communication pathways (not labeled) supporting communication through any communications protocol. The pathways may function in sequence or in parallel, continuously or intermittently. The pathways can use any of the communications standards, protocols or technologies, described herein with respect to a communications network, in addition to standard parallel instruction sets used by many computers.

The nodes may include any entities capable of performing processing functions. Examples of such nodes that can be used with the embodiments include computers (such as personal computers, workstations, servers, or mainframes), handheld wireless devices and wireline devices (such as personal digital assistants (PDAs), modem cell phones with processing capability, wireless e-mail devices including BlackBerry™ devices), document processing devices (such as scanners, printers, facsimile machines, or multifunction document machines), or complex entities (such as local-area networks or wide area networks) to which are connected a collection of processors, as described. For example, in the context of the present invention, a node itself can be a wide-area network (WAN), a local-area network (LAN), a private network (such as a Virtual Private Network (VPN)), or collection of networks.

Communications between the nodes may be made possible by a communications network. A node may be connected either continuously or intermittently with communications network. As an example, in the context of the present invention, a communications network can be a digital communications infrastructure providing adequate bandwidth and information security.

The communications network can include wireline communications capability, wireless communications capability, or a combination of both, at any frequencies, using any type of standard, protocol or technology. In addition, in the present embodiments, the communications network can be a private network (for example, a VPN) or a public network (for example, the Internet).

A non-inclusive list of exemplary wireless protocols and technologies used by a communications network may include BlueTooth™, general packet radio service (GPRS), cellular digital packet data (CDPD), mobile solutions platform (MSP), multimedia messaging (MMS), wireless application protocol (WAP), code division multiple access (CDMA), short message service (SMS), wireless markup language (WML), handheld device markup language (HDML), binary runtime environment for wireless (BREW), radio access network (RAN), and packet switched core networks (PS-CN). Also included are various generation wireless technologies. An exemplary non-inclusive list of primarily wireline protocols and technologies used by a communications network includes asynchronous transfer mode (ATM), enhanced interior gateway routing protocol (EIGRP), frame relay (FR), high-level data link control (HDLC), Internet control message protocol (ICMP), interior gateway routing protocol (IGRP), internetwork packet exchange (IPX), ISDN, point-to-point protocol (PPP), transmission control protocol/internet protocol (TCP/IP), routing information protocol (RIP) and user datagram protocol (UDP). As skilled persons will recognize, any other known or anticipated wireless or wireline protocols and technologies can be used.

The embodiments may be employed across different generations of wireless devices. This includes 1G-5G according to present paradigms. 1G refers to the first generation wide area wireless (WWAN) communications systems, dated in the 1970s and 1980s. These devices are analog, designed for voice transfer and circuit-switched, and include AMPS, NMT and TACS. 2G refers to second generation communications, dated in the 1990s, characterized as digital, capable of voice and data transfer, and include HSCSD, GSM, CDMA IS-95-A and D-AMPS (TDMA/IS-136). 2.5G refers to the generation of communications between 2G and 3G. 3G refers to third generation communications systems recently coming into existence, characterized, for example, by data rates of 144 Kbps to over 2 Mbps (high speed), being packet-switched, and permitting multimedia content, including GPRS, 1xRTT, EDGE, HDR, W-CDMA. 4G refers to fourth generation and provides an end-to-end IP solution where voice, data and streamed multimedia can be served to users on an “anytime, anywhere” basis at higher data rates than previous generations, and will likely include a fully IP-based and integration of systems and network of networks achieved after convergence of wired and wireless networks, including computer, consumer electronics and communications, for providing 100 Mbit/s and 1 Gbit/s communications, with end-to-end quality of service and high security, including providing services anytime, anywhere, at affordable cost and one billing. 5G refers to fifth generation and provides a complete version to enable the true World Wide Wireless Web (WWWW), i.e., either Semantic Web or Web 3.0, for example. Advanced technologies may include intelligent antenna, radio frequency agileness and flexible modulation are required to optimize ad-hoc wireless networks.

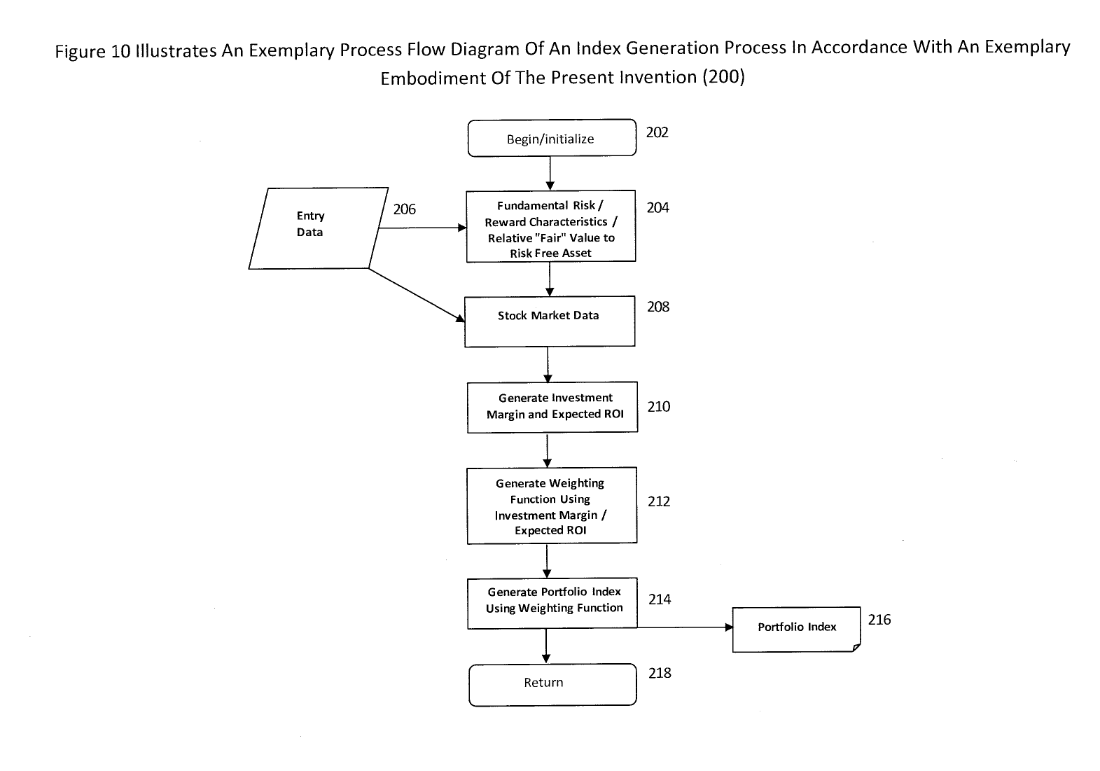

As noted, each node 302, 305 and 308 of FIG. 11 includes one or more processes 303, 307 executable by one or more digital processors incorporated into the nodes. In a number of embodiments, the set of processes 303, 307 separately or individually, can represent entities in the real world, defined by the purpose for which the invention is used. At least one process 303, 307 includes process or procedure 200 of FIG. 10 embodying the methods and principles of the present invention. Turning to FIG. 10, process 200 begins (after initialization 200) with collecting real time stocks and bonds data 206 from an external database 301 of FIG. 11. In process module 204, a series of processes generate risk adjusted relative values by: computing a relative value for each stock of a plurality of stocks, computing an intrinsic return rate for each of the plurality of stocks, computing a consistency of intrinsic return rate for each of the plurality of stocks, computing a discount rate and a risk premium, computing a risk adjusted value, and computing a risk adjusted future value for each of the plurality of stocks Details of each of these computations are provided above. In process module 208 market data 206 are processed from external database 301 and are prepared for use in process step 210. Module or step 210 computes a risk adjusted rate of return on investment for each of the stocks in the plurality of stocks using real time updated market data 206. Process step/module 212 computes a portfolio index of stocks based on the risk adjusted expected return on investment and investment margins using weighting functions described above. Process step 214 then generates the portfolio index 216 using the weighting functions. The process 202-218 is completed by having computed the portfolio index in 216 which selects and weights (automatically adjusts) securities (stocks) in the portfolio. In this way, process 200 and system 300 provide automated portfolio construction and enhanced passive, systematic management of securities therein.

Furthermore, the processes and processors need not be located at the same physical locations. In other words, each processor can be executed at one or more geographically distant processor, over for example, a LAN or WAN connection. A great range of possibilities for practicing the embodiments may be employed, using different networking hardware and software configurations from the ones above mentioned.

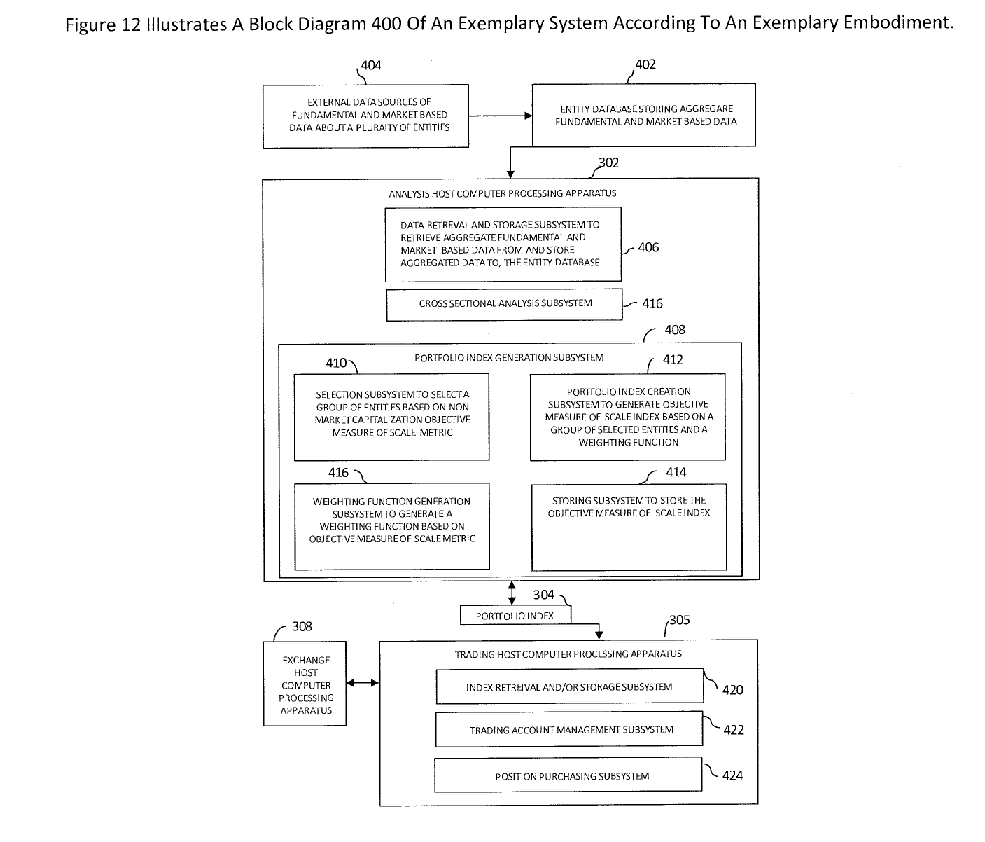

FIG. 12 illustrates block diagram 400 of an exemplary system according to an exemplary embodiment. The system may include an entity database 402 that, according to an exemplary embodiment, may store aggregated accounting based data and/or other data, metrics, measures, parameters, technical parameters, characteristics and/or factors about a plurality of entities, obtained from an external data source 404. The system may include an analysis host computer processing apparatus 302 coupled to the entity database 402. The analysis host computer processing apparatus 302 may include a data retrieval and storage subsystem 406, according to an exemplary embodiment, which may retrieve the aggregated fundamental and market based data from the entity database and may store the aggregated fundamental and market based data to the entity database 402. The analysis host computer processing apparatus 302 may include, according to an exemplary embodiment, a portfolio index generation subsystem 408, which may include, according to an exemplary embodiment, a selection subsystem 410 operative to select a group of the entities based on non-market capitalization objective measure of scale or size metric including one or more technical parameters and/or metrics; a weighting function generation subsystem 416, according to an exemplary embodiment, may be operative to generate a weighting function based on non-market capitalization, non-price related objective measure of scale and/or size metric; an exemplary portfolio index creation subsystem 412, according to an exemplary embodiment, may be operative to create a non-market capitalization non-price objective measure of scale index based on the group of selected entities and/or the weighting function; and/or a storing subsystem 414, according to an exemplary embodiment, operative to store the non-market capitalization, non-price related objective measure of scale and/or size based index, and/or multi-dimensional array of data objects. The index or array of data objects may be stored on a storage device, in one exemplary embodiment.

According to one exemplary embodiment, the system 400 may further include a cross sectional analysis, calculation and/or computation subsystem 416 operative to analyze entity object data to be stored in the entity database 402.

According to another exemplary embodiment, the system 400 may further include a trading host computer system 305 which may include, according to an exemplary embodiment, an index retrieval subsystem 420 operative to retrieve and/or store an instance of the non-market capitalization, non-price related objective measure of scale and/or size based index, and/or multi-dimensional array of data objects from a storage device; a trading accounts management subsystem 422 operative to manage accounts data relating to a plurality of accounts including positions data, position owner data, and position size data, any data of which may be stored in trading accounts database 306; and/or a purchasing subsystem 424 operative to purchase from an exchange host system 308 one or more positions for the position owner, according to the index and/or array of data objects.

### Exemplary Process Control System

According to an exemplary embodiment, the system 400 may be used to compute using data objects input via an input/output subsystem, a multi-dimensional array storing database system for storage of a multi-dimensional array computed via a multi-dimensional object array creation subsystem comprising a selection subsystem operative to select one or more objects based on one or more technical parameters, and a weighting subsystem operative to weight the selected one or more objects based on one or more technical parameters, wherein the technical parameters are chosen such that the technical parameters avoid influence of an undesirable predetermined technical criterion and/or criteria, so as to avoid influence of the undesirable predetermined technical criterion and/or criteria. As a result of elimination of the undesirable predetermined technical criterion and/or criteria, the multi-dimensional array selected and/or weighted to avoid influence of the undesirable predetermined technical criterion and/or criteria may as a result perform processing from negative effects from the undesirable predetermined technical criterion and/or criteria. An exemplary embodiment of the selection subsystem may be operative to select objects from a predetermined universe of objects to obtain a subset of the universe, where the selection is based on a technical parameter that is not influenced by the undesirable technical criterion and/or criteria. Following execution of the selection subsystem, according to an exemplary embodiment, an exemplary weighting subsystem may operative to weight the resulting selected objects by a weighted combination of two or more technical weighting criteria, which are not influenced by the undesirable technical criterion and/or criteria. The process may be used for such technical processes as may include, e.g. but are not limited to, industrial automation, production process automation, a manufacturing process, and/or a chemical processing system, among others as described elsewhere, herein.

According to one exemplary embodiment, the weighting subsystem may further compute an algorithmically computed summation of a plurality of weighting factors, the plurality of weighting factors including a first of the plurality of weighting factors, where the first includes a first given computational product of a first object value and a first technical parameter value associated with the first object value, and a second of the plurality of weighting factors, where the second includes a second given computational product of a second object value and a second technical parameter value associated with the second object value, and/or any additional of the plurality of weighting factors, where the any additional includes an additional given computational product of an additional object value and an additional technical parameter value associated with the additional object value.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents. With regards to an investment portfolio, the related terms “index”, “indexing”, “indexation” and the like generally mean the selection and weighting of securities in the portfolio of interest.

Further, while this invention has been particularly shown and described with references to example embodiments thereof, it will be understood by those skilled in the art that various changes in form and details may be made therein without departing from the scope of the invention encompassed by the appended claims.

What is claimed is:

1. A system of portfolio construction and indexation of a plurality of stocks to a benchmark of investable bonds, said system comprising:
a computer connected to a network, said computer receiving real time data associated with a plurality of stocks in an investment portfolio;
a storage medium connected to said computer and having a program stored thereon, the program executed by the computer and implementing simultaneous indexing of the stocks by:
a. determining a relative value for each stock of the plurality of stocks at time (t₀) by calculating a relative value by dividing a stocks Earnings Per Share at (t₀) by a Risk Free Rate at time (t₀), where time (t₀) is the present time;
b. calculating an intrinsic return rate for each stock of the plurality of stocks for a period of time (t₀-t−ₙ), by dividing the relative value of the stock at time (t₀) by the calculated relative value at time (t−ₙ), where time (t−ₙ) is a point in time in the past, such that the intrinsic return rate is calculated exclusive of a price of the stock;
c. determining a consistency of intrinsic return rate for each stock of the plurality of stocks by calculating a deviation of returns for periodically determined values for the period (t₀-t−ₙ), and then dividing the deviation by the intrinsic return rate;
d. calculating a discount rate at time (t₀) for each stock of the plurality of stocks by multiplying the consistency of intrinsic return rate by the Risk Free Rate at time (t₀) to generate a risk premium, and adding the risk premium to the Risk Free Rate at time (t₀);
e. generating a risk adjusted relative value at time (t₀) for each stock of the plurality of stocks by dividing the earnings at (t₀) by the discount rate at (t₀);
f. calculating a risk adjusted future relative value at time (tₙ) for each stock of the plurality of stocks at time (t₀) by multiplying the risk adjusted relative value at (t₀) with ((1+intrinsic return rate at t₀) A number of periods), where time (tₙ) is a point in time in the future;
g. generating a risk adjusted rate of return on investment at time (t₀) for each stock of the plurality of stocks by dividing the risk adjusted relative future value at time (tₙ) by a market price for the stock at time (t₀); and
h. generating a portfolio index of stocks at time (t₀) based on the risk adjusted expected return on investment for each stock of the plurality of stocks to the benchmark of investable bonds and wherein from the generated portfolio index, the investment portfolio is automatically adjusted for enhanced passive, systematic management of securities therein.

2. The system according to claim 1, wherein determining a relative value of the stock at time (t₀) may be based on either a stocks gross earnings or alternatively on the stocks gross cash flows as a measure of firm size.

3. The system according to claim 1, wherein determining a relative value for a stock at (t₀) is based either a trailing average of earnings and/or cash flows or a composite average of earnings and cash flows for a period (t₀-t−ₙ).

4. The system according to claim 1, wherein the intrinsic return rate is determined as either the average growth rate of one fundamental metric or based on a composite of fundamental metrics for a period (t₀-t−ₙ).

5. The system according to claim 1, wherein the intrinsic return rate is calculated by (t₀) using any of: a compounded annual rate (CAGR), a mean rate, a median rate or a mode rate for a period (t₀-t−ₙ).

6. The system according to claim 1, where a relative value for a stock is determined by dividing an earnings per share at (tₙ) by a discount rate comprising of the yield of a ten year Treasury bond at (t₀) and a risk premium compensating for relative volatility risk across the two competing assets.

7. The system according to claim 1, wherein the deviation may be either a standard or a semi deviation.

8. The system according to claim 1, where dividends or other distributions during a period of time (t₀-t−ₙ) are added to the relative value of the stock at time (t₀) to calculate the intrinsic return rate including distributions.

9. The system according to claim 1, wherein a risk premium further accounts for a general risk premium and/or a default spread.

10. The system according to claim 1, wherein a measurement of market risk exposure is determined as: consistency rate at (t₀) divided by the risk adjusted expected return on investment at (t₀).

11. The system according to claim 1, where a portfolio index is weighted in relative value weights at (t₀).

12. The system according to claim 1, where a portfolio index may further include investable bonds.

13. The system according to claim 11, where a constituent common weight are used to reduce concentration risk in a portfolio.

14. A system for portfolio indexation of a plurality of securities, said system comprising:
a computer operably coupled to a network, said computer receiving real time data associated with a plurality of stocks;
a storage medium operably coupled to said computer and having a program stored thereon, the program is implemented to simultaneously index stocks by:
a. selecting a fundamental metric for a stock at time (t₀);
b. calculating an intrinsic growth rate at (t₀) of the fundamental metric for a period of time (t₀-t−ₙ);
c. determining the deviation rate of the fundamental metric for the period of time (t₀-t−ₙ);
d. calculating a consistency rate for the fundamental metric at time (t₀) by dividing the deviation rate of the fundamental metric at (t₀) by the fundamental metric at (t₀);
e. calculating a risk adjusted fundamental metric by dividing the fundamental metric at (t₀) by (1+the consistency rate) at (t₀);
f. generating a portfolio of a plurality of stocks at time (t₀) by weighting each of the plurality of stocks by its risk adjusted fundamental metric and wherein the generated portfolio is automatically adjusted for enhanced passive, systematic management of securities therein.

15. The system according to claim 14, where a fundamental metric at (t₀) may be a company's: book value, sales, earnings, cash flow and/or dividends.

16. The system according to claim 14, where the fundamental metric at (t₀) may be a composite of two or all of the fundamental metrics.

17. The system according to claim 14, where the fundamental metric at (t₀) is based on a trailing average for the period of time (t₀-t−ₙ).

18. The system according to claim 14, wherein the intrinsic growth rate is: a compounded annual rate (CAGR), or a mean rate, or a median rate or a mode rate, for the period of time (t₀- t−ₙ).

19. The system according to claim 14, where the intrinsic growth rate may be based on a measure of profitability at (t₀).

20. The system according to claim 14, wherein a deviation rate is a standard or semi deviation for the period of time (t₀-t−ₙ).

21. The system according to claim 14, wherein a deviation rate may be calculated on a trailing average of a fundamental metric for the period of time (t₀-t−ₙ) or alternatively on the fundamental metrics growth rate for the period of time (t₀-t−ₙ).

22. The system according to claim 14, wherein the consistency rate is expressed as a factor.

23. The system according to claim 14, wherein the consistency rate at (t₀) is determined by dividing a standard or semi deviation of a fundamental metric for the period of time (t₀-t−ₙ) by the trailing average of a fundamental metric for the period of time (t₀-t−ₙ) or alternatively the last reported data of a fundamental metric at (t₀).

24. The system according to claim 14, where a forward looking risk adjusted fundamental metric at (tₙ) is calculated as the fundamental metric at (t₀) multiplied with ((1+intrinsic return rate)̂number of periods)) at (t₀), where time (tₙ) is a point in time in the future.

25. The system according to claim 24, where a forward looking risk adjusted fundamental metric at (tₙ) is divided by a risk free rate at (t₀), to generate a fair value at (tₙ).

26. The system according to claim 11, where a portfolio index is weighted based on a stock's risk adjusted fundamental metric at (tₙ).

27. The system according to claim 14, where a portfolio index is weighted based on a stock's fair value at (tₙ).

28. The system according to claim 14, where an investment margin at (t₀) is added to a risk adjusted fundamental or fair value at (tₙ) to generate a portfolio weighting system that overweights undervalued stocks and underweights overvalued stocks.
